(19) United States
(12) Patent Application Publication
(10) Pub. No.: US 2026/0350599 A1
(43) Pub. Date: Nov. 5, 2026

(54) RECORDING USER CONSENT IN RELATION TO ELECTRONIC PAYMENT TRANSACTIONS INITIATED BY SOFTWARE AGENTS

(71) Applicant: MASTERCARD INTERNATIONAL INCORPORATED, Purchase, NY (US)

(72) Inventors: Alan Johnson, Maldon (GB); Eugene Reda, Little Falls, NJ (US); Pablo Fourez, Harrison, NY (US)

(73) Assignee: MASTERCARD INTERNATIONAL INCORPORATED, Purchase, NY (US)

(21) Appl. No.: 19/663,881

(22) Filed: Apr. 30, 2026

Related U.S. Application Data
(60) Provisional application No. 63/797,924, filed on Apr. 30, 2025.

(51) Int. Cl. G06Q 20/38; G06Q 20/36; G06Q 20/40; H04L 9/32

(52) U.S. Cl. CPC G06Q 20/3827; G06Q 20/36; G06Q 20/4014; H04L 9/3213; H04L 9/3236

(57) ABSTRACT

Techniques are disclosed for robust capture of user consent relating to an agent-initiated electronic payment transaction (AIT). A hash of a data package containing one or more portions of an interaction between a user and software agent is received by a verification service from a software agent. The verification service generates a token based on the hash of the data package and transmits the token to the software agent. The software agent can subsequently use the token to retrieve the hash and prove that the data package contains the original, unaltered interaction between the software agent and the user, to prove that the user consented to the transaction.

### CROSS-REFERENCE TO RELATED APPLICATIONS

This application claims priority to U.S. Provisional Patent Application No. 63/797,924; filed: Apr. 30, 2025, which is incorporated herein by reference in its entirety.

### FIELD OF INVENTION

This invention relates to electronic payment transactions performed by software agents, and more particularly to techniques for recording user consent to electronic payment transactions initiated by software agents.

### BACKGROUND

Software agents, particularly those implemented using Artificial intelligence (AI), are gaining ever-increasing interest in a variety of areas including electronic payments.

A software agent-initiated transaction (AIT) is distinct from a consumer-initiated transaction (CIT) and a merchant-initiated transaction (MIT) because user consent in respect of the AIT is different from the user consent in respect of a CIT and MIT. Specifically, user consent in respect of an AIT tends to be ‘looser’ than in respect of a CIT and MIT, in the sense that the user may not approve the specifics of a particular transaction (e.g. amount, items for purchase, merchant to purchase the items from, etc.) in the case of an AIT where the user does approve these specifics in the case of a CIT and MIT.

Software agents, particularly AI models, can sometimes misinterpret a user’s intent with the result that one or more electronic payment transactions are performed in a manner that is inconsistent with a user’s intent. For example, a software agent may purchase multiple identical items where the user wanted only one of said item, or purchase an item from a merchant that is unable to deliver the item to the user’s location.

A transaction that a user perceives to be inconsistent with their intent may be challenged by the user. In the case of CITs and MITs it is easy to show what the user consented to as the user specifically approved the parameters of the payment transaction at the time it was initiated in the case of CITs or prior to the initiation of the transaction in the case of MITs.

However, in the case of an AIT, current techniques do not allow for the same analysis to be performed. Specifically, there is no record of the user consenting to the specific transaction(s) that the software agent performed on behalf of the user.

There is therefore a need for a technique that enables robust capture of user consent in the case of an AIT.

### SUMMARY

Techniques are disclosed for robust capture of user consent relating to an agent-initiated electronic payment transaction (AIT). A hash of a data package containing one or more portions of an interaction between a user and software agent is received by a verification service from a software agent. The verification service generates a token based on the hash of the data package and transmits the token to the software agent. The software agent can subsequently use the token to retrieve the hash and prove that the data package contains the original, unaltered interaction between the software agent and the user, to prove that the user consented to the transaction.

In a first aspect, the disclosure provides a computer-implemented method performed as part of an electronic payment transaction, comprising: receiving, by a verification service from a software agent, a hash of a data package comprising one or more portions of an interaction between the user and the software agent; generating, by the verification service based on the hash of the data package, a first token; and transmitting, by the verification service, the first token to the software agent.

In a second aspect, the disclosure provides a computer-readable storage medium having instructions stored thereon, wherein when the instructions are executed by one or more computing devices they cause the one or more computing devices to perform the method of the first aspect.

In a third aspect, the disclosure provides a computing device configured to implement a verification service that performs the method of the first aspect.

### BRIEF DESCRIPTION OF THE DRAWINGS

FIG. 1 is a schematic diagram of a system suitable for implementing some embodiments of the invention.

FIG. 2 is a flow diagram showing a computer-implemented method for reviewing a proposed transaction.

FIG. 3 is a flow diagram showing a computer-implemented method for enabling an AI model to gain access to a payment instrument.

FIG. 4 is a flow diagram showing a computer-implemented method for initiating a review of a proposed payment transaction.

FIG. 5 is a schematic diagram of a system suitable for implementing some embodiments of the invention.

FIG. 6 is a flow diagram showing a computer-implemented method for initiating a payment transaction.

FIG. 7 is a flow diagram showing a computer-implemented method for processing a payment transaction. This method is related to the method of FIG. 6.

FIG. 8 is a flow diagram showing a computer-implemented method for processing a payment transaction. This method is related to the method of FIGS. 6 and 7.

FIG. 9 is a flow diagram showing a computer-implemented method that is performed as part of an electronic payment transaction.

FIG. 10 is a flow diagram showing a computer-implemented method for provisioning a payment credential.

FIG. 11 is a flow diagram showing a computer-implemented method for certifying a software agent for initiating an electronic payment transaction.

FIG. 12 is a flow diagram showing a computer-implemented method that is performed as part of an electronic payment transaction.

FIG. 13 is a flow diagram showing a computer-implemented method for verifying a software agent.

FIG. 14 is a schematic diagram of another system suitable for implementing some embodiments of the invention.

FIG. 15 is a flow diagram showing a computer-implemented authentication method.

FIG. 16 is a flow diagram showing another computer-implemented authentication method.

### DETAILED DESCRIPTION OF EMBODIMENTS

### Terminology

Throughout this disclosure reference is at times made to a ‘software agent’. A software agent is any software that performs actions on behalf of a user, e.g. in the context of e-commerce a software agent may initiate one or more electronic payment transactions on behalf of a user. The software agent may be, or include, one or more AI models (see definition below). Software agents need not be implemented using AI and can alternatively be implemented using a rules-based framework. Software agents of this type are known per se in the art.

Throughout this disclosure reference is at times made to an ‘AI model’. This term is understood to encompass AI agents as well as any other form of AI that is capable of receiving user input in the form of a prompt and acting on said prompt autonomously to fulfil an intent of a user. The intent may be related to an electronic payment transaction, specifically a intent to make one or more purchases.

A prompt is understood to be user input to an AI model. The prompt can be text, speech, etc. A prompt has an associated user intent, i.e. the intention of the user in providing the prompt. Multiple messages may each provide a component of user intent, with the overall combination of messages providing the intent of the user.

Prompts in the context of this disclosure include an intent indicating that a user wishes to perform a payment transaction. In this specification, the term ‘user’ is used interchangeably with the term ‘customer’, ‘consumer’, etc.

Electronic payments are known per se and thus details are not provided herein. It is sufficient to understand that an electronic payment involves the use of a payment credential, e.g. a Payment Account Number (PAN), a token, etc. The payment credential is provided in an autonomous manner by a software agent on behalf of the user to effect payment for goods and/or services. The payment credential is associated with a payment instrument such as a physical credit or debit card, or a virtual card provisioned on an electronic device. Payment instruments of these types are known per se and thus are not described in further detail.

This disclosure is divided into a number of sections each corresponding to a particular theme. These divisions are provided to assist in the understanding of the disclosure and should not be taken as indications that subject matter between different portions of this disclosure cannot be combined. Indeed, unless explicitly stated otherwise, it is contemplated that any feature from one section of this disclosure can be combined with any feature from another section of this disclosure.

### Oversight of a Transaction-Initiating AI Model by Another AI Model

This portion of the disclosure relates to a first AI model that is configured to review electronic payment transactions generated by a second AI model. Advantages of embodiments of this portion of the disclosure may include one or more of: improved accuracy of fully-automated electronic payment transactions carried out by the second AI model, i.e. increased alignment between a user’s intent and the outcome (i.e. the purchase(s)) autonomously made by the second AI model; a reduction in use of resources, e.g. physical and/or electronic resources, to address mistakes, errors, etc. in electronic payment transactions performed autonomously by the second AI model; and/or improvement of user experience relating to autonomous electronic payments carried out by the second AI model.

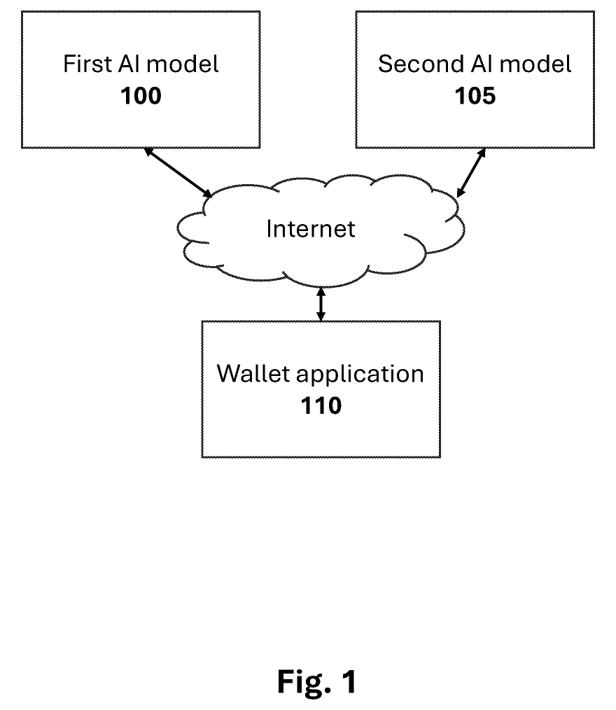

Referring to FIG. 1, a system capable of performing embodiments of this portion of the disclosure is shown. The system includes a first AI model 100, a second AI model 105 and a wallet application 110. Each of these components is implemented by a corresponding computing device. Each of these components can be implemented by a different computing device, or the same computing device may implement one or more of first AI model 100, second AI model 105 and wallet application 110. In the case where different computing devices are present, said computing devices are communicatively coupled to one another via a communication network such as the internet.

Here, ‘implemented’ refers to the computing device executing instructions, computer code, etc. that enables the computing device to perform the functions of the respective component(s) that the computing device is implementing. Functions of first AI model 100, second AI model 105 and wallet application 110 are detailed later in this document.

The nature of the or each computing device is not restricted by the disclosure and as such any computing device can be used. The computing device may be a physical device or a virtual device.

In an embodiment, first AI model 100 is implemented by a cloud computing device that is part of a payment network, second AI model 105 is implemented by a cloud computing device that is part of another network, and wallet application 110 is implemented by a user device such as a mobile phone, laptop, tablet, desktop, gaming console, Internet of Things (IoT) device, and the like. The disclosure is not limited to this configuration, however.

Second AI model 105 generally performs the function of carrying out electronic payment transactions on behalf of a user. Second AI model 105 may be referred to as an AI agent. Second AI model 105 may be trained to interpret user prompts provided in various forms such as natural language text or speech. Second AI model 105 does not need to be specifically trained to perform electronic payments; that is, second AI model 105 may be a generic AI model trained to interpret user prompts relating to any matter, not just electronic payments. Second AI model 105 may be any type of AI model, e.g. a large language model (LLM) such as ‘ChatGPT’ as provided by OpenAI™.

First AI model 100 generally performs the function of checking an electronic transaction attempt that is made by second AI model 105. To facilitate such checking, first AI model 100 is trained on historic payment network transaction data and the transaction data. Historic payment network transaction data refers to data relating to electronic payments that have previously been approved. Historic payment network transaction data includes data relating to many such electronic payments. Such data may be any one or more of: a merchant identifier, a customer identifier, details of one or more goods and/or services ordered as part of the transaction, a location of the transaction, a date and/or time of the transaction, a total value of the transaction, value(s) of one or more specific goods and/or services ordered as part of the transaction, and the like. First AI model 100 can be any type of AI model, e.g. an LLM.

Any known techniques for training an AI model can be used to train first AI model 100 and/or second AI model 105.

Some operations are described herein as being performed by an AI model. AI models, particularly AI agents, are capable of writing code on the fly to perform tasks. Description herein of performance of an operation by an AI model should thus be understood to encompass the AI model writing code, e.g. a script, to perform the corresponding operation. Thus, interactions between any AI model described herein and another AI model or a software application such as wallet application 110 can be performed using code such as a script written by the respective AI model and involving the use of application programming interface(s) (APIs). Fully automated interaction (i.e. without manual intervention) between the components shown in FIG. 1 is thus encompassed by this disclosure.

Wallet application 110 generally performs the function of securely storing one or more payment instruments and their respective payment credentials. Wallet applications of this type are known per se in the art and thus further details are not provided here. It is sufficient to understand that wallet application 110 enables another party, specifically second AI model 105 in the context of this disclosure, to identify a set of available payment instruments, select a particular payment instrument from the set of available payment instruments and request use of a payment credential corresponding to the selected payment instrument.

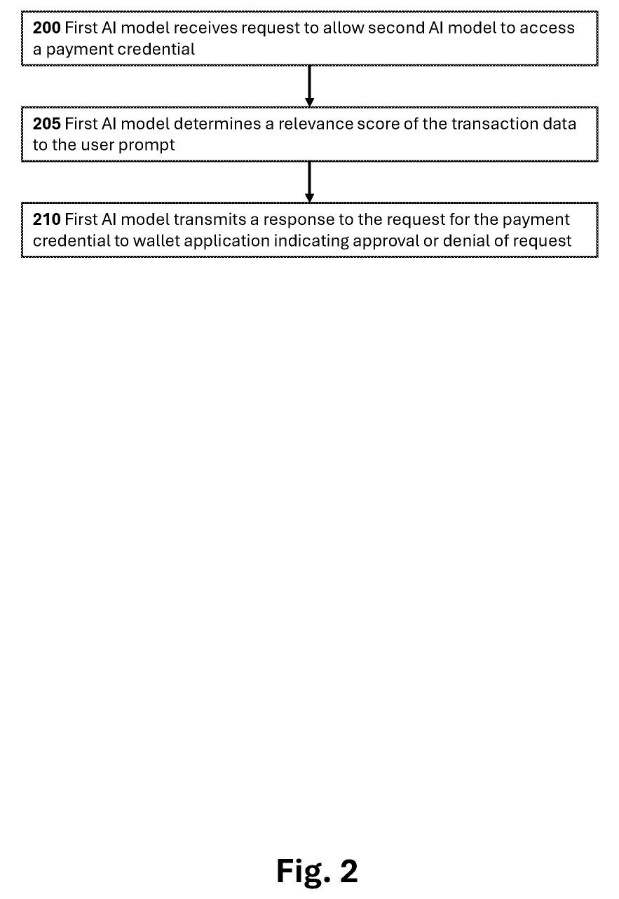

Referring to FIG. 2, a method for reviewing an electronic payment transaction proposal is shown. As used herein, the term ‘electronic payment transaction proposal’ refers to a transaction that second AI model 105 proposes to perform based on a user prompt that second AI model 105 has received. The method of FIG. 2 reviews this proposal for consistency with the user’s intent and enables the proposed transaction to proceed in the case where the proposed transaction is considered likely to result in an outcome consistent with the user’s intent.

In step 200, first AI model 100 receives a request to allow second AI model 105 to obtain access to a payment credential held by wallet application 110. Here, the term ‘held’ indicates that wallet application 110 is able to access the payment credential. The payment credential can be a card PAN or tokenised PAN, for example.

The request comprises a user prompt provided to second AI model 105 by a user. The user prompt includes a payment intent, i.e. the user prompt indicates that the user intends to make a purchase of some kind. Some exemplary textual prompts of this nature are as follows:
I need a new winter coat.
Get me something for dinner for tomorrow night.
Buy me a coffee from a shop close to me.
Get a present for my brother’s birthday next week.
Do my grocery shopping for the week.
Pay for my dry cleaning.

These prompts are purely exemplary. It will be appreciated that, due to the nature of AI prompts, there are virtually infinite variations for prompts that include a payment intent.

User prompts may include additional information such as constraints, e.g. ‘Do not spend more than X amount’, ‘I need this by 5pm tomorrow’, or ‘This must be no more than 30 minutes’ drive from where I am now’. These constraints contribute towards the user’s intent, as a good or service that satisfies the core intent of the prompt may not satisfy the constraint and thus do not represent an accurate fulfilment of the user’s complete intent.

The request also comprises transaction data generated by second AI model 105 in response to the user prompt. The transaction data is associated with the payment transaction that second AI model 105 is proposing to make. The transaction data represents the second AI model’s interpretation of the user prompt. The transaction data can be understood to be an electronic transaction proposal made by the second AI model 105.

The transaction data can comprise any data that is relevant to the payment transaction proposal. For example, the transaction data can comprise: one or more goods and/or services for purchase, details of a merchant that is offering to sell said one or more goods and/or services, a cost of said one or more goods and/or services, a total cost of the transaction, and the like. The transaction data may be compliant with a payment standard, e.g. the Europay Mastercard Visa (EMV) payment standard as is known in the art.

Ideally, the transaction data accurately reflects the user’s intent. Given the prompt ‘I need a new winter coat’, second AI model 105 would ideally generate transaction data corresponding to a purchase of a single winter coat from a merchant that offers shipping to the user’s residence. Such a transaction can be approved. Transaction data corresponding to a purchase of multiple winter coats, another item of apparel such as a shirt, or a winter coat from a merchant that does not ship to the user’s residence, would not accurately reflect the user’s intent and such transaction proposals should therefore not be approved.

The user prompt received by first AI model 100 may be in ciphertext. In this case, the user prompt is encrypted in a manner such that only first AI model 100 can decrypt the ciphertext to obtain the plaintext user prompt. This can advantageously preserve user privacy and ensure that sensitive data relating to the user is not accessible in plaintext form by any entity that is not authorised to obtain such data.

In step 205, first AI model 100 determines a relevance score of the transaction data to the user prompt based on a set of inputs comprising the user prompt and the transaction data. The relevance score is a quantified measure of the relevance of the transaction data to the user prompt, i.e. the relevance score quantifies the degree to which a transaction carried out on the basis of the transaction data matches the intent of the user given the user prompt. The relevance score is generated by first AI model 100 by inputting the set of inputs and outputting the relevance score. As first AI model 100 is trained on historic payment network transaction data, it is expected that first AI model 100 will be more effective than second AI model 105 at correctly interpreting the user prompt and ascertaining the user’s intent in relation to a payment transaction.

The set of inputs may also comprise any other data that is considered to be useful in assisting first AI model 100 in the generation of the relevance score. For example, the set of inputs may also comprise user data relating to the user and/or a transaction history relating to the user. The user data can be any data relating to the user, e.g. age, height, weight, gender, current location, home address, work address, medical information, financial information such as user spending power, user preferences such as brand preferences, colour preferences, etc., user spending expectations, user social media information such as social media handles of accounts controlled by the user, a time that the user provided the prompt to second AI model 105, details of an electronic device that the user used to provide the prompt to second AI model 105, and the like.

The transaction history relating to the user contains information of previous purchases made by the user. The transaction history may be stored by wallet application 110. Each transaction in the transaction history can include data such as: a merchant identifier, an itemised list of goods and/or services purchased, a cost of each good and/or service purchased, a total value of the transaction, a date and/or time that the transaction took place, a location at which the transaction took place, etc. The transaction history may identify any transactions that were refunded, indicating dissatisfaction of the user.

In step 210, first AI model 100 transmits a response to the request for the payment credential to wallet application 110, the response indicating approval or denial of the request for the payment credential. The response is based on a comparison of the relevance score to a threshold relevance score.

The relevance score can be expressed in any suitable form, e.g. a value between 0 and 1, where 0 is ‘completely irrelevant’ and 1 is ‘perfectly relevant’. The comparison involves comparing the relevance score to the threshold relevance score. Transactions associated with transaction data having a relevance score greater the threshold relevance score may be approved by first AI model 100. Transactions associated with transaction data having a relevance score less than the threshold relevance score may be denied by first AI model 100. Transactions associated with transaction data having a relevance score equal to the threshold relevance score may be either approved or denied by first AI model 100, depending on implementation preferences. That is, the following possibilities are envisaged:

Relevance score greater than or equal to threshold relevance score, approve; else, decline.

Relevance score greater than threshold relevance score, approve; else, decline.

It will be appreciated that approval of the request for the payment credential enables second AI model 105 to gain access to the payment credential and thus carry out the electronic payment transaction. Conversely, denial of the request for the payment credential prevents second AI model 105 from gaining access to the payment credential such that the electronic payment transaction cannot be performed. In this manner, first AI model 100 acts as a check on second AI model 105, increasing the likelihood that payment transactions autonomously carried out by second AI model 105 match a user’s intent. User experience is thus improved. Additionally, actions required to correct the results of transactions that do not match a user’s intent are reduced.

Optionally, approving the request further comprises the first AI model 100 transmitting a request to wallet application 110 to provide the payment credential to either the second AI model 105 or a payment service provider of a merchant associated with the payment transaction. This enables second AI model 105 to use the payment credential to perform an electronic payment transaction resulting in goods and/or services in accordance with the user’s intent.

The request to wallet application 110 may include a set of hashes, wherein each hash in the set of hashes corresponds to a respective input in the set of inputs. Each hash can be generated using any known hash algorithm, e.g. Secure Hash Algorithm (SHA).

Taking the case where the set of inputs includes the user prompt and the transaction data as an example, the user prompt may be hashed using the hash algorithm to generate a user prompt hash and the transaction data may also be separately hashed using the hash algorithm to generate a transaction data hash. The set of hashes in this case comprises the user prompt hash and the transaction data hash.

The set of hashes may also include an output hash of the output of first AI model 100. This output can be the relevance score, for example. The output hash can be generated by applying the hash function to the output.

Providing the payment credential by wallet application 110 can include generating a cryptogram, e.g. an EMV cryptogram in accordance with the EMV standard. The cryptogram can be generated based on the set of hashes. The set of hashes can be in addition to the usual set of inputs for generating a cryptogram, e.g. as defined by the EMV standard.

It will be appreciated that the set of hashes provide a record of the data on which basis the payment transaction was approved. This links the payment transaction to other relevant information such as the user’s prompt, the transaction data generated by the second AI model 105 and the decision of the first AI model 100. This is useful in the event of a dispute arising after the transaction has taken place.

In the case where first AI model 100 denies the request for the payment credential, the response may include one or more reasons for the denial of the request for the payment credential. The reasons may indicate one or more elements of the transaction data received in step 200 as the primary factor(s) contributing to the denial. Second AI model 105 may modify the payment transaction based on the reason(s) for the denial and initiate the method of FIG. 2 again using revised transaction data. The revised transaction data may be based on the original transaction data with element(s) modified based on the reason(s) for denial.

The one or more reasons for the denial may be provided in the form of a modified prompt. The modified prompt can be generated by first AI model 100 based on the reason(s) for refusal. Second AI model 105 can use the modified prompt to generate new transaction data, with the likelihood being that the new transaction data better matches the user’s intent.

For example, if a reason for denial is that the total value of the transaction significantly exceeds an amount the user typically spends for a transaction of that nature, first AI model 100 can adapt the original prompt to include wording such as ‘Do not spend more than X on this purchase’.

As another example, if a reason for denial is that the merchant cannot deliver the product in a timely manner, first AI model 100 can adapt the original prompt to include wording such as ‘Delivery must occur by <date & time>’, where <date & time> is a timestamp or other such representation of a date and time.

This process can be repeated a number of times. In this way a feedback loop can be set up such that first AI model 100 causes second AI model 105 to converge towards a payment transaction that satisfactorily matches the user’s intent. Advantageously, this can improve user experience because the user is unaware of the denied transactions and simply sees a payment transaction consistent with their intent being made.

It will be appreciated that, in the case where the outcome of step 210 is approval, an electronic payment transaction can proceed. Authorisation data of the electronic payment transaction can include the set of hashes discussed above as well as the cryptogram generated based in part on the set of hashes. This enables a payment network operator or an issuer to verify the cryptogram based on the user prompt and transaction data generated by second AI model 105 in addition to the typically-used parameters in a known authorisation request.

The authorisation data is processed according to known transaction authorisation techniques, such that details are not provided herein. Preferably, wallet application 110 receives a transaction result corresponding to the electronic payment transaction. Wallet application 110 can store the transaction result in a historical database of all electronic payment transactions made by the user. Contents of the historical database can be provided to first AI model 100 in connection with a future transaction attempt by second AI model 105. Historical data of this type will tend to increase the accuracy of the relevance score calculated by first AI model 100 because the historical data can be used to better understand the user’s intent. For example, multiple transaction attempts made by second AI model 105 over a short timeframe (e.g. seconds, minutes) that each relate to purchase of the same goods and/or services can be detected as inconsistent with user intent since it is unlikely a user intends to purchase the same goods and/or services multiple times in a short timeframe.

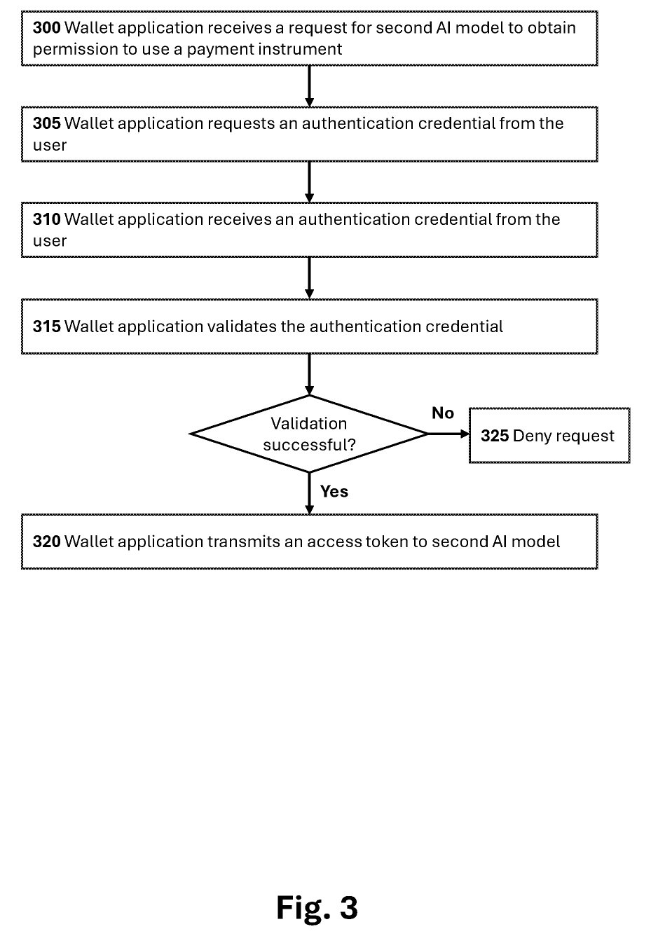

Referring now to FIG. 3, operations of wallet application 100 are discussed. The operations of FIG. 3 relate to configuring the system of FIG. 1 appropriately such that second AI model 105 can request to perform electronic payment transactions according to the process of FIG. 2. The operations shown in FIG. 3 thus occur prior to step 200 of FIG. 2.

In step 300, wallet application 100 receives a request for second AI model 105 to obtain permission to use a payment instrument associated with the payment credential. The request can be sent by second AI model 105. The request can include an identifier of the payment instrument that the second AI model 105 wishes to receive permission to use. The payment instrument is one of a set of one or more payment instruments held by wallet application 100. Storing of a digital payment instrument in a software application like wallet application 100 is known in the art per se and as such details are not provided here.

The request can be made in respect of a plurality of payment instruments, each having respective payment credentials. In this case, one of the plurality of payment instruments is the payment instrument discussed above.

In step 305, wallet application 110 requests an authentication credential from the user. The request can be in the form of a user interface. For example, wallet application 110 can cause the user interface to be displayed to the user, where the user interface includes an indication of the payment instrument(s) that second AI model 105 is seeking to obtain permission to use. The user interface may include a user interface element configured to enable the user to provide an authentication credential to wallet application 110, e.g. a PIN or password entry field, a ‘capture biometric’ user interface element, and the like. Such user interface elements are known per se and thus further details are not provided here. The authentication credential may be compliant with the Open Authentication (OAuth) standard known in the art.

In step 310 wallet application 110 receives an authentication credential from the user and in step 315 wallet application 110 validates the authentication credential. Techniques for receipt and validation of authentication credentials are known per se and thus further details are not provided here.

In the case where wallet application 110 successfully validates the authentication credential, in step 320 wallet application 100 transmits an access token corresponding to the payment instrument(s) to second AI model 105. The access token is specific to second AI model 105, meaning that the access token is usable only by second AI model 105. Advantageously, binding second AI model 105 to the payment instrument(s) in this manner improves security because it reduces the likelihood of another AI model operated by a bad actor gaining the ability to attempt to use the payment instrument(s) held by wallet application 110 in electronic payment transactions.

The permission granted to second AI model 105 can be unlimited or it can be limited. Unlimited permission allows second AI model 105 to attempt to use the payment instrument(s) in any manner. Limited permission places limits on second AI model 105 in terms of what it may use the payment instrument(s) for. Limits may be, for example, any one of more of: a validity time period for the permission after which the access token provided in step 320 is revoked, a maximum value of any single purchase, a cumulative maximum value of multiple purchases over a time period, rules regarding type(s) of merchant at which purchases are permitted or denied, geographical restrictions, etc.

It should be kept in mind that even in the unlimited permission case, first AI model 100 serves as a check on the actions of second AI model 105. That is, first AI model 100 can still prevent second AI model 105 from using the payment instrument in payment transactions that are not in accordance with user intent.

In the case where limited permission is provided, the user may be prompted to indicate limitations they wish to impose before providing the authentication credential. For example, a user interface comprising a mechanism for supplying the authentication credential may also include user interface elements (e.g. buttons, text entry fields) for specifying one or more limitations.

In the case where the authentication credential cannot be successfully validated, in step 325 wallet application 110 denies the request made by second AI model 105 in step 300. In this case, second AI model 105 is not provided with an access token such that second AI model 105 cannot attempt to use the payment instrument(s) held by wallet application 110 to make electronic payments.

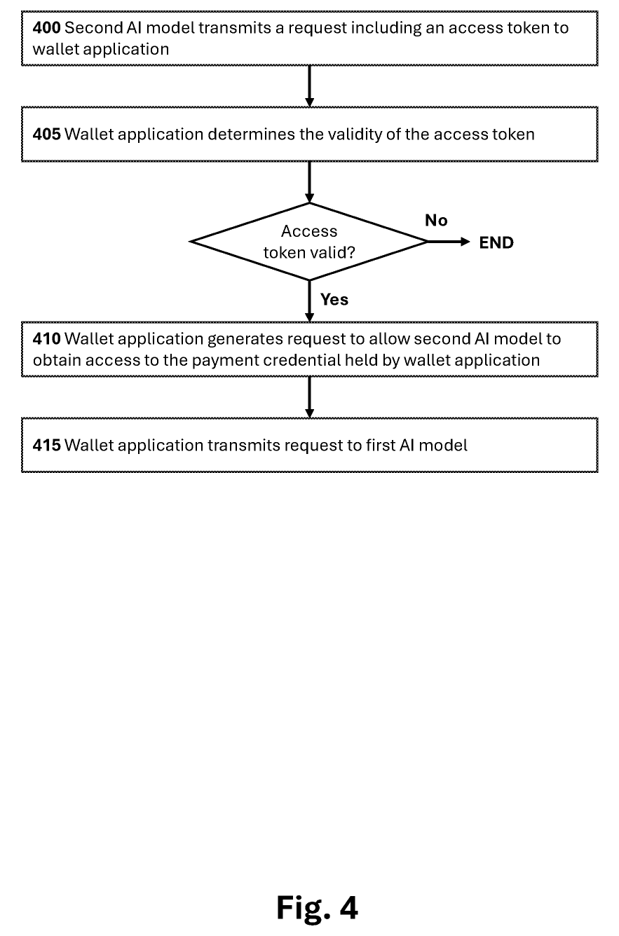

Referring now to FIG. 4, further operations are discussed. The operations shown in FIG. 4 correspond to actions performed by second AI model 105 and wallet application 110 prior to step 200 of FIG. 2 and after step 320 of FIG. 3. Note that the operations of FIG. 4 are performed only in the case where the request made by second AI model 105 in step 300 of FIG. 3 is approved.

In step 400, second AI model 105 transmits a request to use the payment instrument to wallet application 110. The request includes the access token provided to second AI model 105 in step 320 of FIG. 3.

In the case where wallet application 110 holds multiple payment instruments that second AI model 105 has been granted approval to use, i.e. the access token (or equivalently a plurality of access tokens associated with a respective one of the multiple payment instruments) allows second AI model 105 to attempt to use multiple payment instruments in an electronic payment transaction, step 400 can include second AI model 105 selecting one of the multiple payment instruments for the electronic payment transaction.

Second AI model 105 can perform the payment instrument selection based on metadata associated with each payment instrument, where the metadata is provided by wallet application 110. Examples of metadata that may be provided by wallet application 110 include: merchant-related benefits for a payment instrument such as an offer when using the payment instrument at a specific merchant, a statement date associated with the payment instrument, a credit limit and/or balance associated with the payment instrument, issuer-provided offers such as cashback or points associated with the payment instrument, and the like.

In step 405, wallet application 110 determines the validity of the access token. If the access token is determined to be invalid, the process ends.

In the case where the access token is determined to be valid, in step 410 wallet application 110 generates the request to allow second AI model 105 to obtain access to the payment credential held by wallet application 110. In step 415, wallet application 110 transmits the request to allow second AI model 105 to obtain access to the payment credential held by wallet application 100 to first AI model 100. Receipt of this request by first AI model 100 corresponds to step 200 of FIG. 2.

The operations of FIG. 4 thus serve to allow second AI model 105 to attempt to carry out a payment transaction. Advantageously, any AI model that does not have an access token cannot trigger step 400 and is thus prevented from submitting a request to carry out an electronic payment transaction to first AI model 100. This ‘gated’ configuration can reduce load on first AI model 100; specifically, computing resources providing the functions of first AI model 100 are used only to assess transaction requests from AI models that are authorised to submit such electronic payment transaction requests. This also improves security as it is difficult for an AI model that is operated by a bad actor to obtain an access token, this being a prerequisite for said AI model to attempt to perform electronic payment transactions. Thus, even an AI model that obtains a valid payment credential is prevented from attempting to perform electronic payments.

### Payment Acceptance Interface for Software Agent

This portion of the disclosure relates to a payment acceptance interface that is configured for use by a software agent, e.g. second AI model 105.

Existing payment acceptance interfaces present challenges for software agents because these payment acceptance interfaces are designed for human users rather than software agents. For example, existing payment acceptance interfaces require human input, e.g. filling in text fields, pressing buttons and the like. Existing software agents such as ‘auto-complete’ attempt to fill in as much as possible of these fields, but typically fall short of a truly automated process.

Embodiments of this portion of the disclosure can address the problems above by providing a payment acceptance interface designed specifically for software agents.

Advantages of embodiments of this portion of the disclosure may include one or more of: improved efficiency of electronic payment transactions initiated autonomously by a software agent; improved security of electronic payment transactions initiated autonomously by a software agent; and/or improved user experience relating to electronic payment transactions initiated autonomously by a software agent.

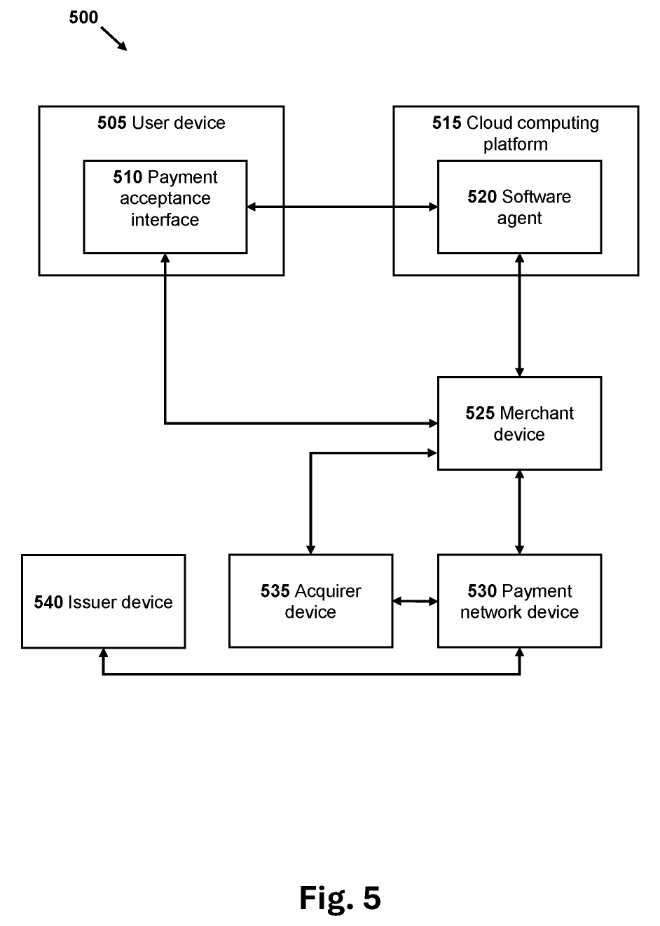

Referring to FIG. 5, a system 500 capable of implementing embodiments of this section of the disclosure is shown.

In system 500, arrows indicate communicative couplings between the elements at the respective endpoints of the arrows. Communication takes place electronically over a network such as the internet, a LAN, a WAN, a cellular network, etc. Electronic communication of this nature is known in the art and thus details are not provided here. It will be appreciated that system 500 can include multiple different types of network to support communication between its various elements.

System 500 includes a user device 505 that implements payment acceptance interface 510. User device can be any electronic device that a user interacts with, e.g. a phone, tablet, laptop, desktop computer, gaming consoles, smart watch or other such wearable smart item, an Internet of Things (IoT) device, etc.

Here, implementing payment acceptance interface 510 means that user device 505 enables a user to access to payment acceptance interface 510. Examples of such implementations include: an application installed on user device 505 providing payment acceptance interface functionality in the form of one or more graphical user interfaces associated with the application; a web-based payment acceptance interface presented to the user via a web browser application executed by user device 505, and the like.

Payment acceptance interface 510 is configured to enable electronic payment transactions to be initiated on behalf of the user. Payment acceptance interfaces per se are known in the art. However, it should be noted that known payment acceptance interfaces are configured primarily for human usage. While payment acceptance interface 510 may be configured for human usage, in embodiments of this portion of this disclosure it should be understood that payment acceptance interface 510 is additionally, or alternatively, configured for use by a software agent (e.g. second AI model 105) to autonomously initiate an electronic payment transaction. Further details of this are provided later in this portion of this disclosure.

If payment acceptance interface 510 supports human interaction, payment acceptance interface 510 can have any form known in the art, e.g. one or more graphical user interface elements interpretable by a human. Alternatively, if payment acceptance interface 510 is not configured to support human interaction, payment acceptance interface 510 can comprise code or an equivalent machine-readable format without any accompanying graphical user interface elements.

Payment acceptance interface 510 is provided by a merchant associated with merchant device 520. Providing payment acceptance interface 510 is understood to mean that the merchant makes payment acceptance interface 510 available to software agent 520 (and optionally also to a human user of user device 505) in some manner to facilitate automated initiation of electronic payment transactions by software agent 520.

The presence of payment acceptance interface 510 can be signalled to software agent 520 in some way. For example, a web page or software application provided by the merchant can include a webhook, tag, or other such machine-readable element that is detectable by software agent 520 and which indicates details of the payment acceptance interface 510.

Alternatively, software agent 520 can use a lookup service to query whether a particular merchant offers a payment acceptance interface like payment acceptance interface 510. The query can be based on any identifier associated with the merchant that software agent 520 can obtain, e.g. merchant name, merchant domain name, merchant identifier. These identifiers can be obtained from a human-readable portion of the merchant’s online presence, e.g. scraped from a webpage operated by the merchant or obtained from an application operated by the merchant. The response to the query indicates whether the merchant offers a machine-readable payment interface and, if yes, details of payment interface 510 can be provided in the query response. The lookup service can be provided by payment network device 530, for example, or the lookup service may be provided by another entity that is not part of system 500, e.g. a merchant aggregator or online marketplace.

System 500 also includes cloud computing platform 515 that implements AI model 520. Cloud computing platforms are known in the art and thus details are not provided here. It is sufficient to understand that software agent 520 is executed by a component of cloud computing platform 515, e.g. one or more physical and/or virtual machines of cloud computing platform 515.

Software agent 520 is configured to perform autonomous electronic payment transactions. Software agent 520 can be, or include, an AI model such as second AI model 105. Reference is made here to the earlier discussion relating to second AI model 105.

It is also contemplated that software agent 520 may be executed solely by user device 505. In this case, cloud computing platform 515 can be omitted. It is further contemplated that software agent 520 can be implemented in a distributed manner whereby some components of software agent 520 are executed by cloud computing platform 515 and other components of software agent 520 are executed by user device 505.

System 500 also includes merchant device 525. Merchant device 525 can be any computing device(s) operated by a merchant. Merchant device 525 may be implemented by a cloud computing platform, e.g. cloud computing platform 515 or a different cloud computing platform.

Merchant device 525 implements a software interface, e.g. an Application Programming Interface (API), to facilitate communication with software agent 520. Such software interfaces are known per se in the art and thus details are not provided here. It is sufficient to understand that merchant device 525 is configured to enable software agent 520 to communicate with merchant device 525 in an automated manner.

Merchant device 525 can advertise the availability of the software interface in various ways. As one example, a webhook or tag(s) can be provided within a human-readable payment acceptance interface. The webhook / tag(s) may be provided in one or more webpages that are part of a human-readable payment acceptance interface.

A software agent interacting with the human-readable payment acceptance interface can detect the webhook / tag(s) / other such indicator and thus understand that the merchant operating the human-readable payment acceptance interface also provides a second payment acceptance interface in the form of a software interface that is tailored for use by a software agent such as software agent 520. The webhook / tag(s) / indicator can indicate an address of the software interface, enabling software agent 520 to locate the software interface and initiate communication via the software interface. Software agent 520 can thus use the software interface to initiate an electronic payment transaction instead of the human-readable payment acceptance interface, leading to improved transaction efficiency, reduced time for performing the transaction and/or an improved user experience.

As another example, the presence of the software interface can be indicated via code within a merchant application. The merchant application can be installed on user device 505. The code may be a particular module, or part of a module, that facilitates communication via the software interface. The code can provide the address of the software interface to enable software agent 520 to communicate via the software interface.

As a further example, the presence of the software interface can be provided by a lookup service. The lookup service maintains a database of merchants that provide software interfaces and the respective addresses of the software interfaces. User device 505 can query the lookup service, e.g. using a merchant identifier, merchant domain name, etc., to determine whether a specific merchant provides a software interface. In the case where the merchant does provide a software interface, the lookup service can respond with the address of the software interface. The lookup service can be implemented by a component of system 500, e.g. payment network device 530, or by another computing device that is not part of system 500.

It is possible for payment acceptance interface 510 to provide information to software agent 520 via the software interface. This information can be any information that is considered useful by the merchant operating payment acceptance interface 510 for software agent 520 to have. For example, the information can include one or more of: an indication of remaining inventory of the merchant; and a list of payment methods accepted by the merchant. This information can be used by software agent 520 to further improve the efficiency of the electronic payment transaction process.

Merchant device 525 is configured to implement a merchant endpoint (not shown in FIG. 5). The term endpoint as used herein refers to software and/or hardware operated by the merchant that is configured to enable programmatic communication with other components of system 500, particularly (although not necessarily exclusively) software agent 520. A merchant endpoint can take the form of one or more APIs, for example. The merchant endpoint can be implemented by the same computing device(s) used to implement merchant device 525, or different computing device(s). In the latter case, the merchant endpoint may be communicatively coupled to merchant device 525.

Merchant device 525 is generally configured to assist in the processing of electronic payment transactions. Specific actions performed by merchant device 525 are discussed later in this section.

System 500 further includes payment network device 530. Payment network device 530 can be any computing device(s) operated by a payment network operator. Payment network device 530 may be implemented by a cloud computing platform, e.g. cloud computing platform 515 or a different cloud computing platform.

Payment network device 530 is generally configured to assist in the processing of electronic payment transactions. Specific actions performed by payment network device 530 are discussed later in this section.

System 500 further includes acquirer device 535. Acquirer device 535 can be any computing device(s) operated by an acquirer. Acquirers per se are known in the art. Acquirer device 535 may be implemented by a cloud computing platform, e.g. cloud computing platform 515 or a different cloud computing platform.

Acquirer device 535 is generally configured to assist in the processing of electronic payment transactions. Specific actions performed by acquirer 535 are discussed later in this section.

System 500 also includes issuer device 540. Issuer device 540 can be any computing device(s) operated by an issuer. Issuers per se are known the in art. Issuer device 540 may be implemented by a cloud computing platform, e.g. cloud computing platform 515 or a different cloud computing platform.

Issuer device 540 is generally configured to assist in the processing of electronic payment transactions. Specific actions performed by issuer 540 are discussed later in this section.

It will be appreciated that FIG. 5 is simply one exemplary way in which system 500 can be configured. Cloud computing and virtualisation are both well known technologies and as such a skilled person will be able to conceive of many variations to the specific configuration shown in FIG. 5. Such variations also constitute embodiments of the disclosure, provided they are capable of implementing one or more methods discussed in this portion of the disclosure. Any component shown in FIG. 5 can be virtualised and/or implemented by one or more computing devices.

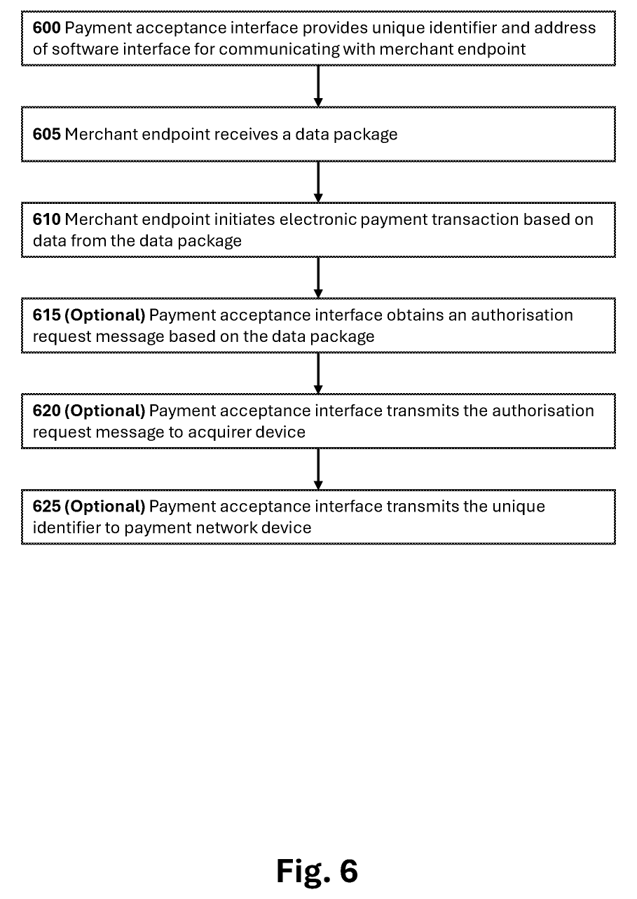

Referring now to FIG. 6, a method for initiating an electronic payment transaction is described. This method involves payment acceptance interface 510 of FIG. 5 that may be provided by merchant device 525.

The method of FIG. 6 is performed in a scenario in which software agent 520 seeks to initiate an electronic payment transaction based on user input to software agent 520. Before the method of FIG. 6 is performed, software agent 520 can interact with a traditional human-oriented interface provided by the merchant to identify one or more goods and/or services to purchase based on a user prompt. Reference is made here to the corresponding discussion earlier in this disclosure in relation to second AI model 105 interpreting a user prompt to determine a user intent corresponding to a purchase.

In step 600, payment acceptance interface 510 provides a unique identifier corresponding to an electronic shopping basket and an address of a software interface for communicating with a merchant endpoint.

The unique identifier may be referred to as a ‘cart ID’. This information can be obtained from merchant device 525 or any other computing device operated by the merchant. The merchant endpoint can be implemented by merchant device 525, for example.

Payment acceptance interface 510 is configured for software agent 520 to interact with it in a programmatic manner and may optionally also be configured to enable a human user to interact with it in a traditional non-programmatic manner. Communication in a programmatic manner is facilitated by the software interface that is provided by the payment acceptance interface. The software interface is configured to enable software to software communication. An example of a software interface is an Application Programming Interface (API). APIs are known in the art and so further details regarding APIs are not provided here.

The address of the software interface can be any information that enables software agent 520 to communicate electronically with the merchant endpoint via the software interface, e.g. an Internet Protocol (IP) address, a Uniform Resource Locator (URL), a Uniform Resource Identifier (URI), etc. The address and unique identifier can be provided via any mechanism that is interpretable by software agent 520, e.g. via a webhook or tag embedded in a merchant webpage, or in response to a query to a lookup service as described above.

The electronic shopping basket contains one or more goods and/or services that software agent 520 is seeking to autonomously purchase on behalf of a user. Electronic shopping baskets per se are known in the art and therefore details are not provided here. It is sufficient to understand that electronic shopping basket enables one or more goods and/or services that are to be purchased electronically to be identified.

In step 605, the merchant endpoint receives a data package comprising the unique identifier and transaction data generated based on the electronic shopping basket. The data package is received via the software interface from software agent 520. The data package can also comprise any one or more of: a cryptogram corresponding to the transaction data, user authentication data and/or software agent identification data.

Generation of cryptograms is known per se and thus details are not provided here. User authentication data is also known per se in the art such that details are not provided here. Software agent identification data comprises any data that enables software agent 520 to be identifier, e.g. a string of characters identifying software agent 520.

In step 610, the merchant endpoint initiates the electronic payment transaction based on the transaction data and the unique identifier. It will thus be appreciated that the software interface of the payment acceptance interface enables a software agent to send standard transaction-related data as well as supplemental data such as authentication data, software agent identification data and/or a cryptogram to the merchant endpoint in a programmatic manner. User intervention is therefore not required because the software agent can handle the entire process of triggering an electronic payment transaction by itself in an efficient manner.

Further optional actions can be performed following step 610. These actions are discussed below.

In optional step 615, the payment acceptance interface obtains an authorisation request message based on the data package. The authorisation request message can be generated by the payment acceptance interface 510, merchant device 525 (e.g. by the merchant endpoint), software agent 520 or another component of system 500. The authorisation request message can be generated in a conventional manner e.g. in accordance with the EMV standard as is known in the art.

In optional step 620, the payment acceptance interface transmits the authorisation request message to acquirer device 535. Acquirer device 535 can be configured to process the authorisation request message in a conventional manner.

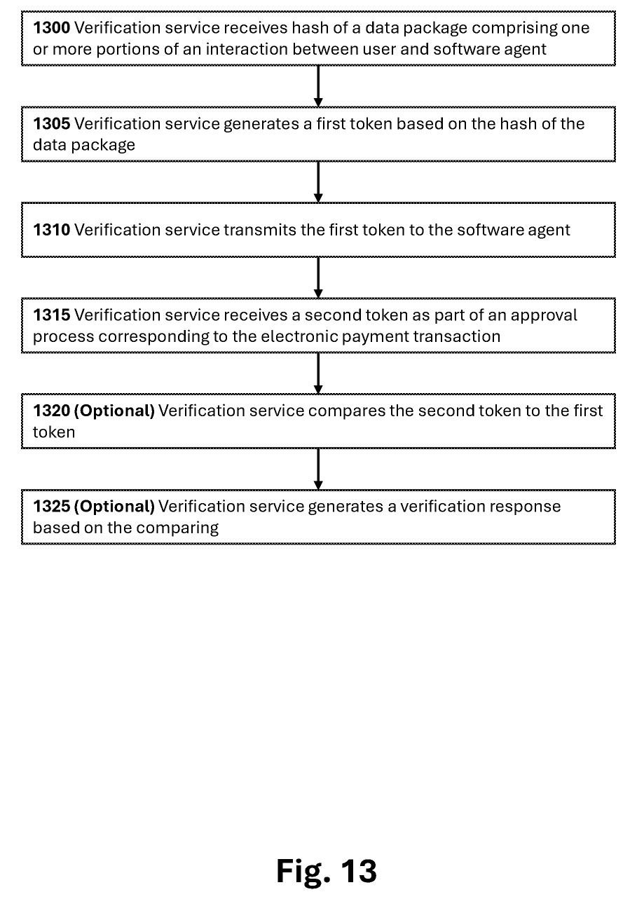

In optional step 625, the payment acceptance interface transmits the unique identifier to payment network device 530. Any additional data provided by software agent 520 that is not part of the authorisation request message can also be transmitted to payment network device 530 in step 625. Such data might include a data package containing at least a portion of an interaction between software agent 520 and the user, as discussed in more detail later in connection with FIG. 13.

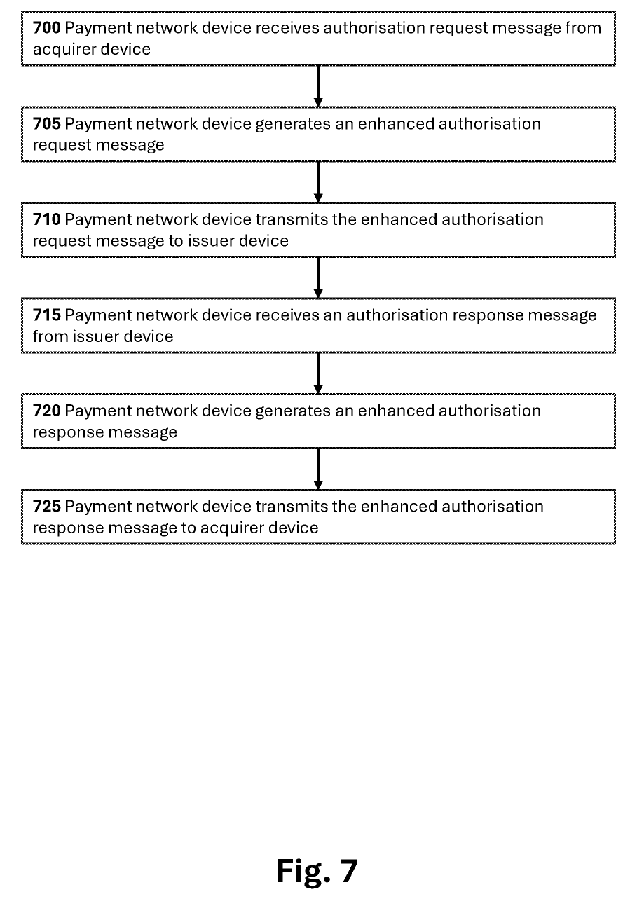

Referring now to FIG. 7, a method for initiating an electronic payment transaction is described. This method can be implemented by system 500, and specifically by payment network device 530. It will be appreciated that the method of FIG. 7 is complementary to the method of FIG. 6.

In step 700, payment network device 530 receives the authorisation request message from acquirer device 535.

In step 705, payment network device 530 generates an enhanced authorisation request message. The term ‘enhanced’ is used here to distinguish from a conventional authorisation request message. An enhanced authorisation request message includes additional data that facilitates autonomous AI transactions of the type discussed throughout this disclosure.

The enhanced authorisation request message comprises authorisation request data from the authorisation request message of step 615, a flag indicating that the enhanced authorisation request message relates to an electronic transaction initiated by an AI model (e.g. AI model 520), the unique identifier corresponding to AI model 520 obtained in step 605 and a risk score and/or confidence score relating to the electronic payment transaction.

The risk score and/or the confidence score can be generated by payment network device 530. The risk score comprises a value quantifying the risk associated with approving the electronic payment transaction. The risk score can be a value in a range between a lower bound and an upper bound, e.g. between 0 and 1, where a low value represents low risk and a high value represents high risk. The risk score is not limited to this configuration, however, as any scale that enables quantification of risk can be used (e.g. the range is instead 0 to 100).

The risk score can be calculated based on information relating to software agent 520. A parameter that can be used in the risk score calculation is whether the software agent 520 has a certification of the type discussed in a later portion of this disclosure. A certified software agent can be assigned a low risk score and an uncertified software agent can be assigned a high risk score.

The risk score can additionally or alternatively be calculated based on information relating to the electronic payment transaction. For example, a total value of the transaction may be considered when calculating the risk score, with a higher total value being assigned a corresponding higher risk score and a lower total value being assigned a corresponding lower risk score.

The risk score can additionally or alternatively be calculated based on information relating to the user, e.g. based on user authentication data. For example, valid authentication data provided by the user can result in a low risk score whereas invalid user authentication data provide by the user can result in a high risk score.

Any other parameter(s) considered relevant to assessing the risk associated with approving a particular payment transaction can additionally or alternatively be included in the risk score calculation.

The risk score can be formed of multiple components that are summed to generate the risk score. The sum may be a weighted sum where each component has an equal or unequal weighting.

The confidence score comprises a value quantifying the confidence that the electronic payment transaction satisfies the user intent. The confidence score can be a value in a range between a lower bound and an upper bound, e.g. between 0 and 1, where a low value represents low confidence (i.e. the transaction is unlikely to satisfy the user’s intent) and a high value represents high confidence (i.e. the transaction is likely to satisfy the user’s intent). The confidence score is not limited to this configuration, however, as any scale that enables quantification of confidence can be used (e.g. the range is instead 0 to 100).

The confidence score can be based on an analysis of user input data and transaction data of the electronic payment transaction to estimate the degree to which the transaction is likely to satisfy the user’s intent. This analysis can be performed by a software agent such as first AI model 100.

The confidence score can be formed of multiple components that are summed to generate the confidence score. The sum may be a weighted sum where each component has an equal or unequal weighting.

The enhanced authorisation request message can be generated by modifying the data structure of the authorisation request message of step 615. Alternatively, authorisation request data contained within the authorisation request message of step 615 can be extracted and inserted into the enhanced authorisation request message. The authorisation data can comprise any data included in a conventional authorisation request message as is known per se in the art. It will be appreciated that in either case the enhanced authorisation request message is advantageously backwards-compatible with legacy systems that do not support one or more embodiments of this portion of the disclosure. Specifically, as the authorisation data is contained within the enhanced authorisation request message, a legacy system can process the enhanced authorisation request message in the usual manner as though it were a conventional authorisation request message. To further facilitate this, preferably the format of the authorisation data in the enhanced authorisation request message is the same as the format of the authorisation data in the authorisation request message.

The flag indicating that the enhanced authorisation request message relates to an electronic transaction initiated by AI model 520 can take any form that enables a component of system 500, e.g. merchant device 525, payment network device 530, acquirer device 535 and/or issuer device 540, to identify that enhanced authorisation request message relates to an electronic transaction initiated by AI model 520, i.e. that the enhanced authorisation request message is an enhanced authorisation request message rather than a conventional authorisation request message.

The flag can be explicit, e.g. one or more bits of the enhanced authorisation request message denoting a flag can be set to indicate that the enhanced authorisation request message is an enhanced authorisation request message. For example, a flag bit can be set to ‘1’ in the case where the enhanced authorisation request message is an enhanced authorisation request message.

The flag can alternatively be implicit, e.g. the fact that a unique identifier corresponding to AI model 520 is present in the enhanced authorisation request message can itself be used as the flag. Another device of system 500 can thus understand that any authorisation request message containing a unique identifier corresponding to an AI model is an enhanced authorisation request message.

In step 710, payment network device 530 transmits the enhanced authorisation request message to issuer device 540.

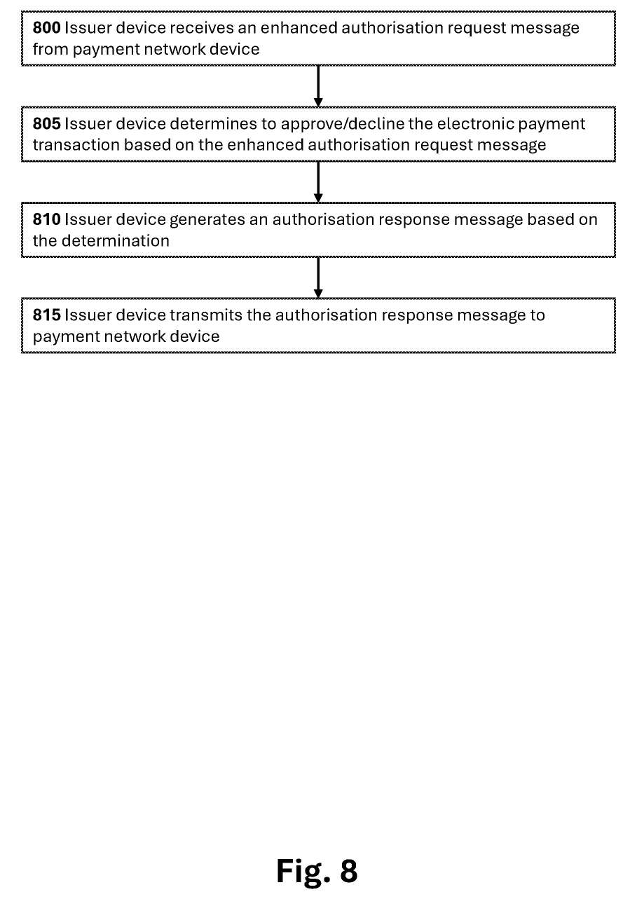

In step 715, payment network device 530 receives an authorisation response message from issuer device 540. The authorisation response message indicates approval or denial of the electronic payment transaction and includes authorisation response data. The authorisation response message can be a conventional authorisation response message as is known per se in the art. Reference is made here to FIG. 8 and the accompanying description as this provides further details on issuer device 540 determining whether to approve or decline the electronic payment transaction.

In step 720, payment network device 535 generates an enhanced authorisation response message comprising the authorisation response data, a flag indicating that the enhanced authorisation response message relates to an electronic transaction initiated by a software agent and the unique identifier corresponding to the software agent. If calculated, a risk score and/or a confidence score of the type discussed above may also be included in the enhanced authorisation response message.

The enhanced authorisation response message can be generated in an analogous manner to the generation of the enhanced authorisation request message and reference is therefore made here to the earlier discussion on the generation of the enhanced authorisation request message.

The flag indicating that the enhanced authorisation response message relates to an electronic transaction initiated by an AI model can be implemented in the same manner as the flag indicating that the enhanced authorisation request message relates to an electronic transaction initiated by an AI model. Reference is therefore made here to the earlier discussion regarding the flag indicating that the enhanced authorisation request message relates to an electronic transaction initiated by an AI model.

In step 725, payment network device 530 transmits the enhanced authorisation response message to acquirer device 535. Acquirer device 535 can take any action typically performed by an acquirer on receipt of a conventional authorisation response message, e.g. depositing funds in a bank account of the merchant operating merchant device 525 in the case where the enhanced authorisation response message indicates that the electronic payment transaction is approved.

Advantageously, the enhanced authorisation response message contains the additional data discussed in connection with steps 700 and 720 above. An identity of the software agent that initiated the electronic payment transaction is thus known to the payment network operation, acquirer and issuer. In the event of a future query relating to the transaction, e.g. a refund request or a dispute, any of the entities can use this additional data to resolve the query in an efficient and user-friendly manner.

As part of step 725, payment network device 530 or another entity in system 500 may transmit a transaction result to software agent 520. The transaction result is based on the authorisation response message received in step 710. The transaction result indicates whether the electronic payment transaction initiated by software agent 520 was approved or denied. In the case where the transaction was denied, the transaction result may include one or more reasons for denial. The one or more reasons may be based on the unique identifier corresponding to the AI model, the risk score and/or confidence score, if present.

Referring now to FIG. 8, a method for authorising an electronic payment transaction is described. This method can be implemented by system 500, and specifically by issuer device 540. It will be appreciated that the method of FIG. 8 is complementary to the method of FIG. 6 and to the method of FIG. 7.

In step 800, issuer device 540 receives an enhanced authorisation request message from payment network device 530. The enhanced authorisation request message is of the type discussed above in connection with FIG. 7.

In step 805, issuer device 540 determines whether to approve or decline the electronic payment transaction based on the enhanced authorisation request message.

The determination made by issuer device 540 is therefore based on both conventional authorisation request message data and the additional data included in the enhanced authorisation request message (see discussion above in connection with FIG. 7). That is, issuer device 540 determines whether to authorise the electronic payment transaction based on the unique identifier corresponding to software agent 520 and also the risk score and/or confidence score, if present. This can enable more effective decision-making on the part of issuer device 540.

For example, an authorisation request that a conventional issuer would approve based solely on the authorisation request data may instead be declined by issuer device 540 due to the unique identifier corresponding to software agent 520, the score risk and/or confidence score.

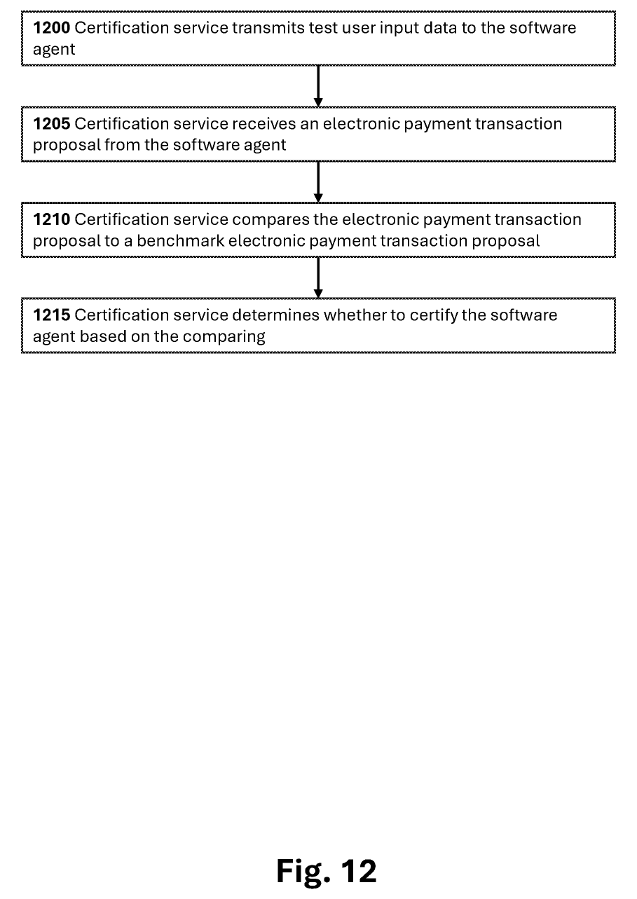

For example, issuer device 540 may determine based on the unique identifier corresponding to software agent 520 that software agent 520 is not certified for performing the electronic payment transaction. This could be, for example, because the electronic payment transaction relates to goods and/or services that lie outside of an area of expertise of software agent 520. Issuer device 540 may contact a certification service (see discussion later corresponding to FIG. 12) to assist in making this determination.

Additionally or alternatively, the risk score and/or confidence score may be compared to a risk score threshold and/or a confidence score threshold to determine whether the electronic payment transaction is sufficiently low risk and/or sufficiently high confidence to be authorised.

In step 810, issuer device 540 generates an authorisation response message based on the determination of step 805. The authorisation response message is of a conventional type, e.g. an authorisation response message that is consistent with the EMV standard. The enhanced authorisation response message indicates whether the electronic payment transaction is authorised or not authorised.

In step 815, issuer device 540 transmits the authorisation response message to payment network device 530. In this manner, payment network device 530 is made aware of the issuer’s decision as to whether to approve the electronic payment transaction.

It will be appreciated that the software interface discussed above in connection with this portion of the disclosure enables any data to be exchanged between a software agent and back-end components of a payment network, e.g. merchant device 525 and payment network device 530. It should therefore be understood that any reference throughout this disclosure to data transmission between a software agent and a back-end component of a payment network can be facilitated by this software interface.

### Identifying Agent-Initiated Transactions

This portion of the disclosure relates to techniques for identifying agent-initiated electronic payment transactions. Such electronic payment transactions can be initiated by software agent 520 or by second AI model 105. Advantages of embodiments of this portion of the disclosure may include one or more of: improved security of electronic payment transactions initiated autonomously by a software agent and improved efficiency of operating an electronic payment network. These advantages are provided whilst ensuring compatibility with legacy systems because issuers and acquirers do not need to update their respective systems for embodiments of this portion of the disclosure to function correctly.

Embodiments of this portion of this disclosure can be carried out by one or more components of system 500 of FIG. 5. Reference is thus made to the components of FIG. 5 here.

Reference is made in this portion of the disclosure to ‘provisioning’. This is a term of art that refers to a process in which a payment credential is generated and provided to an entity for that entity’s use. The entity can be any type of payment instrument, e.g. a physical or virtual card. In the context of this portion of the disclosure, the entity is a software agent such as software agent 520. Techniques for securely provisioning payment credentials are known per se in the art such that details are not provided here. The following discussion assumes that successful provisioning has taken place.

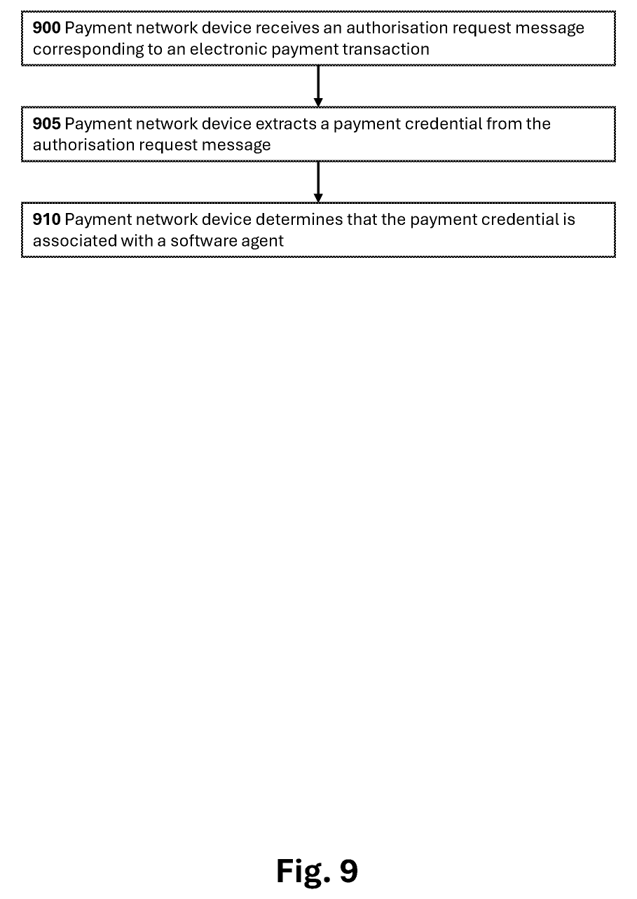

Referring now to FIG. 9, in step 900 payment network device 530 receives an authorisation request message corresponding to the electronic payment transaction. The authorisation request message comprises authorisation request data. The authorisation request message can be conventional in format meaning that legacy acquirer and issuer systems can process the authorisation request message in the normal manner known in the art. However, this is not limiting as authorisation request messages that are not in a conventional format are also possible.

The authorisation request message can be received from merchant device 525 as is conventional. Alternatively, the authorisation request message can be received directly from the software agent via a communication channel established between the software agent and payment network device 530. Further details on such a communication channel are provided later.

In step 905, payment network device 530 extracts a payment credential from the authorisation request message. Extraction encompasses any technique for obtaining the payment credential from the authorisation request message, e.g. reading one or more fields of the authorisation request message to obtain data stored in said one or more fields. The payment credential can be formed by the data read from the one or more fields, e.g. the data read from the one or more fields can be concatenated to form the payment credential.

The payment credential is preferably conventional in format to provide legacy compatibility, although this is not required as payment credentials and/or authorisation request messages that diverge in format from existing authorisation request messages and/or payment credentials are possible.

In step 910, the payment network device determines that the payment credential is associated with a software agent (e.g. software agent 520). This determination can be made in several ways.

In a first embodiment, the determining that the payment credential is associated with a software agent comprises the following actions.

Payment network device 530 can query a database to retrieve a record associated with the payment credential. The database can be part of system 500, e.g. a database maintained by the payment network operator. Any database that is accessible to payment network device 530 is suitable.

The database contains one or more records. Each of the one or more records includes at least a payment credential. Other data may be present in each record, e.g. an identifier of the entity that the payment credential is provisioned to, a date and time of provisioning, etc. The query above can therefore have the payment credential itself as the subject of the query, such that database is searched for records containing the payment credential and any such matching records are returned as a result of the query.

The database can be a general provisioning database that stores records corresponding to each instance of provisioning of a payment credential (e.g. a token) to an entity. In this case, an identifier (e.g. a flag) can be set in records where the entity is specifically a software agent. When a record matching the payment credential is found, payment network device 530 can examine the identifier to determine whether the payment credential is provisioned to a software agent or other entity. For example, a one-bit flag can be used as the identifier, where this flag takes a particular value (e.g. ‘1’) where the payment credential is provisioned to a software agent.

Alternatively, the database can contain a list of payment credentials that are provisioned to software agents specifically. In this case the database could be, for example, a software agent-specific provisioning database or a particular data table within the general provisioning database discussed directly above where this table holds records corresponding only to payment credentials that have been provisioned to software agents. In this case recognition that the payment credential is provisioned to a software agent can be implicit, i.e. the presence of a payment credential within this database / data table is sufficient to enable a determination that the payment credential is provisioned to a software agent to be made. That is, in this case a query that results in a match is sufficient to inform payment network device 530 that the payment credential is provisioned to a software agent. An identifier as discussed above can thus be omitted, although this is not limiting as the identifier can be present if desired.

In any of the cases above, payment network device 530 can determine, using the record, that a payment credential type of the payment credential is a software agent payment credential type. Payment credential type refers to the type of entity that a payment credential is provisioned to, with ‘software agent’ being the most relevant payment credential type to the present discussion.

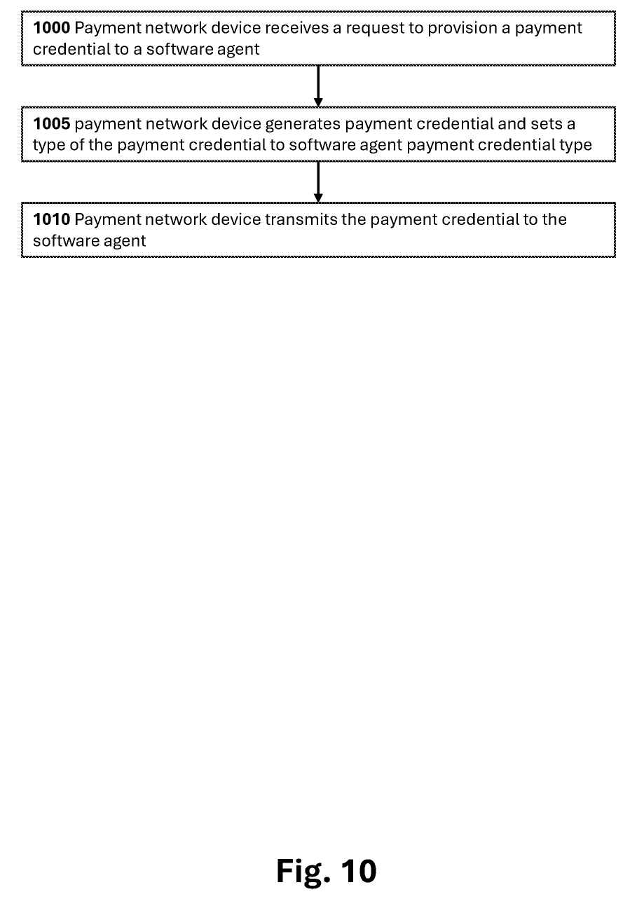

Any form of database as discussed above can be populated at the time of provisioning a payment credential. During the provisioning process (see FIG. 10), a provisioning service (e.g. provided by payment network device 530 or a provisioning device) can obtain information about the entity that is requesting a payment credential. Specifically, the provisioning service can obtain entity type information that relates to the type of entity that is requesting the payment credential. The entity type can include ‘software agent’ as a possible value. Software agent may be further distinguished into sub-types, e.g. ‘AI model-based software agent’ and ‘non AI-model based software agent’. Entity type can be self-reported by the requesting entity, or entity type can be determined by the provisioning service, e.g. by requiring the entity requesting a payment credential to identify itself in some manner (e.g. providing an identifier credential) or perform a task that only an entity of a certain type can successfully complete.

Additional information obtained at the time of provisioning can also be stored in the database, e.g. as part of, or in association with, the record that stores the payment credential that has been provisioned. The additional information can be any information relating to the software agent that the payment credential is being provisioned to. Examples include but are not limited to any combination of: a certification credential indicating that the software agent is certified to initiate electronic payment transactions, a risk score associated with the software agent, a confidence score associated with the software agent and/or a unique identifier associated with the software agent. This supplemental information can have utility in other operations performed in connection with an electronic payment transaction, e.g. being used as data on which to make a decision by an issuer on whether to authorise or decline a transaction. Reference is made here to discussion in other portions of this disclosure relating to software agent certification, risk scores and confidence scores.

The first embodiment is particularly suited to environments in which a conventional payment acceptance interface is provided, i.e. where the authorisation request message is obtained by payment network device 530 via merchant device 525. In this environment, a communication channel between software agent 520 and payment network device 530 is not available.

However, the first embodiment is not limited to use in such environments as the authorisation request message can be received from the software agent via a communication channel established between the software agent and payment network device 530. This communication channel can be implemented by payment acceptance interface 510 discussed earlier, for example. Specifically, a payment network endpoint can be provided in addition to, or instead of, the merchant endpoint discussed above to support a communication channel between software agent 520 and payment network device 530. The payment network endpoint functions in the same manner as the merchant endpoint. Additionally, the presence of the payment network endpoint can be advertised to software agent 520 in the same manner as the merchant endpoint. Reference is thus made here to the discussion above in respect of the merchant endpoint which each equally applicable to the payment network endpoint.

In a second embodiment, determining that the payment credential is associated with a software agent comprises the following actions. In the second embodiment, a communication channel between software agent 520 and payment network device 530 is available. The communication channel can be established as discussed above.

In the second embodiment, payment network device 530 can receive a data package comprising a unique identifier of the software agent. The data package is sent via the communication channel between the software agent and payment network device 530.

The unique identifier of the software agent can be of any form, e.g. a string of alphanumeric characters, a globally unique identifier (GUID), a hash of all or part of a codebase corresponding to the software agent, etc. The unique identifier can be assigned to the software agent at the time of provisioning the payment credential, e.g. by the provisioning service discussed above.

In this case, payment network device 535 can use the unique identifier of the software agent to query a database to retrieve a record associated with the unique identifier.

Upon identification of such a record, payment network device 535 can determine, using the record, that a payment credential type of a payment credential associated with the record is a software agent payment credential type. Reference is made at this point to the earlier discussion regarding payment credential type as this discussion is equally applicable here.

In this embodiment, the payment credential can be a dynamic payment credential. That is, the payment credential can include one or more dynamic fields. The value of the dynamic field(s) changes, e.g. every transaction, every N transactions (N being an integer greater than 1), after a certain amount of time has passed (e.g. a 1 hour, 24 hours, 1 week, 1 month, etc.), etc. This can improve security because a third party that obtains a particular instance of the payment credential is unable to use it to perform future transactions since that instance of the payment credential is only valid for a limited amount of time.

The data package can include further information in addition to the unique identifier of the software agent. The additional information can be any information relating to the software agent that the payment credential is being provisioned to. Examples include but are not limited to any combination of: a certification credential indicating that the software agent is certified to initiate electronic payment transactions, a risk score associated with the software agent, a confidence score associated with the software agent and/or a unique identifier associated with the software agent. This supplemental information can have utility in other operations performed in connection with an electronic payment transaction, e.g. being used as data on which to make a decision by an issuer on whether to authorise or decline a transaction. Reference is made here to discussion in other portions of this disclosure relating to software agent certification, risk scores and confidence scores.

The data package can also include authentication data relating to the user that is associated with the transaction, i.e. the user that provided a prompt or otherwise instructed the software agent to initiate an electronic payment transaction. The authentication data can be any type of authentication data known in the art, e.g. a pin, or password provided by a user and/or or biometric data. The authentication data may be provided to the software agent by the user in advance of the software agent initiating a payment transaction, e.g. as part of an interaction such as a chat or voice interaction between the user and the software agent.

Including authentication data in the data package can improve security as transaction attempts made by a software agent that do not provide authentication data, or that provide invalid authentication data, can be detected by payment network device 530 and declined by payment network 530.

Referring to the earlier discussion relating to provisioning a payment credential, FIG. 10 shows a method for provisioning a payment credential. The method of FIG. 10 is performed before the method of FIG. 9, i.e. before payment network device 530 receives the authorisation request message.

In step 1000, payment network device 530 receives a request to provision a payment credential to a software agent, e.g. software agent 520. This provisioning request can be received directly from the software agent via a communication channel of the type discussed above, or the provisioning request can be received via any other component shown in FIG. 5.

In step 1005, payment network device 530, generates the payment credential and sets a type of the payment credential to a software agent payment credential type. Generation of payment credentials is known per se and as such further details are not provided here.

Step 1005 may also include payment network device 530 generating a unique identifier for the software agent. The unique identifier can be transmitted to the software agent by payment network device 530. Alternatively, the unique identifier can be provided by the software agent as part of, or accompanying, the provisioning request.

In both of the above cases, payment network device 530 can store the unique identifier in a database. The unique identifier is stored in association with the payment credential. The database can be of the type discussed above.

Step 1005 may additionally include payment network device 530 generating a risk score associated with the software agent and/or a confidence score associated with the software agent. Further details on the generation of a risk score and confidence score are provided in an earlier portion of this disclosure. Payment network device 530 can store the risk score and/or the confidence score in the database in associated with the unique identifier, such that this additional information is available for subsequent retrieval.

In step 1010, payment network device 530 transmits the payment credential to the software agent. The payment credential is thus provisioned to the software agent and ready for the software agent to use, e.g. when implementing the method of FIG. 9.

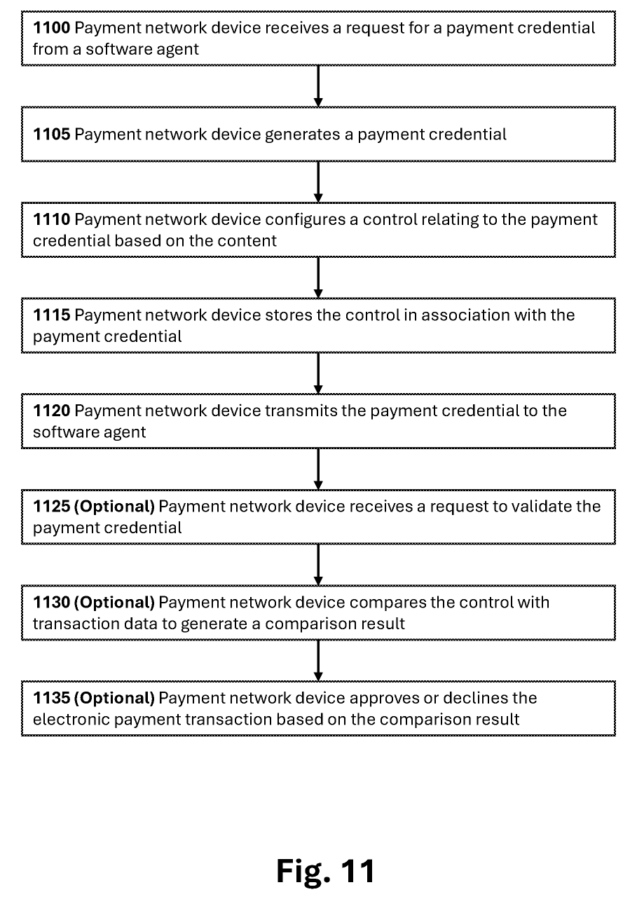

One or more elements of the payment credential provisioning process discussed below in connection with FIG. 11 may be combined with, or replace, one or more elements of the payment credential provisioning process of FIG. 10.

### Provisioning of Payment Credentials Having Controls

This portion of the disclosure relates to techniques for provisioning of controlled or limited-use payment credentials. Payment credentials of this type can be used in connection with embodiments described in any part of this document where a payment credential is discussed. Advantages of embodiments of this portion of the disclosure may include one or more of: improved user experience relating to electronic payments performed by software agents; improved security relating to electronic payments performed by software agents; and/or a reduction in fraud associated with electronic payments performed by software agents.

Embodiments of this portion of this disclosure can be carried out by one or more components of system 500 of FIG. 5. Reference is thus made to the components of FIG. 5 here, particularly software agent 520 and payment network device 530.

Referring to FIG. 11, a method for provisioning a controlled or limited-use payment credential is shown. In the discussion below, payment network device 530 is described as implementing the steps of FIG. 11. Payment network device 530 may provide a credential provisioning service to perform some or all of the steps of FIG. 11. The credential provisioning service may be executed by payment network device 530 or by a different computing device on behalf of payment network device 530.

In step 1100, payment network device 530 receives a request for a payment credential from a software agent, e.g. software agent 520. The request includes a data package containing content of an interaction between the software agent and a user. The content at least partially relates to an electronic payment transaction, e.g. a discussion between the software agent and a user in which the user signals their intent to purchase one or more goods and/or services.

The request may be transmitted via a communication channel established between the software agent and payment network device 530, e.g. in the manner discussed in earlier portions of this disclosure.

The data package can be of any format, e.g. XML, JSON, etc. as are known in the art.

The content of the interaction between the software agent and a user can take many forms and will depend on the form in which the software agent and the user interacted.

As one example, in the case of a text interaction (‘chat’) between the software agent and the user, the content of the interaction between the software agent and the user can comprise text from this interaction. The text, often called a ‘chat’, ‘chat history’ or ‘chat log’, can be the entire interaction or one or more parts thereof. For example, the software agent may be configured to review the full text interaction and extract one or more parts that specifically relate to an electronic payment transaction. The software agent may be, or make use of, an AI model to perform this review, e.g. second AI model 105.

As another example, in the case of an audio interaction or video interaction between the software agent and the user, the content of the interaction between the software agent and the user can comprise audio from this interaction. This is referred to as an audio recording of the interaction. The audio can be an audio recording the entire interaction, or audio recording(s) one or more parts thereof. For example, the software agent may be configured to review the full audio recording interaction and extract one or more parts that specifically relate to an electronic payment transaction. The software agent may be, or make use of, an AI model to perform this review, e.g. second AI model 105.

Mixed-type interactions are also contemplated, e.g. a user speaking to a software agent that responds in a written form, or vice versa. In such cases the content of the interaction between the software agent and a user can be a combination of text and audio recording(s) corresponding to one or more parts of the interaction.

It is also possible for an audio recording of an interaction to be transcribed, e.g. by the software agent, where the transcription of the audio recording, or one or more parts thereof, is provided in the data package instead of, or in addition to, the audio recording itself. The software agent may be, or make use of, an AI model to perform the transcription, e.g. second AI model 105.

It is also contemplated that the interaction may comprise image(s) and/or hyperlink(s). The data package can include one or more such images and/or hyperlinks. The image(s) and/or hyperlink(s) may be provided by the user or the software agent.

In step 1105, payment network device 530 generates a payment credential. Techniques for generating payment credentials are known per se and as such further details are not provided here. Referring briefly to FIG. 10, payment network device 530 may set a type of the payment credential to a software agent payment credential type as part of step 1105.

In step 1110, payment network device 530 configures a control relating to the payment credential based on the content. Configuring a control can involve payment network device 530 processing the content within the data package to identify a requirement relating to an electronic payment transaction. The control can be set based on the requirement.

The manner that payment network device 530 processes the content within the data package can depend on the nature of the data itself. In the case of text, one or more text processing techniques can be employed, e.g. natural language processing-based techniques. Similarly, in the case of audio data or image data, a corresponding audio or image analysis technique can be used to analyse the audio or image. Techniques for performing text, audio and image analysis are known per se in the art and thus details are not provided here.

Payment network device 530 may use an AI model to perform the processing of the content within the data package. The AI model could be first AI model 100, for example.

Irrespective of the specific technique(s) used, the goal of the technique(s) is to identify payment-related elements of the content that explicitly or implicitly place a constraint, requirement etc. on any payment transaction(s) that result from the interaction corresponding to the content.

It will be appreciated that appropriate requirements / constraints will vary according to the specifics of a given situation. The following non-exhaustive list sets out possible requirements / constraints:
a maximum value of the electronic payment transaction;
a minimum value of the electronic payment transaction;
an attribute (e.g. colour, size, brand, make, model, etc.) of a good and/or service that is to be purchased as part of the electronic payment transaction;
a payment instrument that is approved to be used in the electronic payment transaction;
a payment account that is approved to be used to fund the electronic payment transaction;
a payment method that is approved to be used in the electronic payment transaction;
an identifier of a merchant that is approved to be a counterparty in the electronic payment transaction;
a category of a merchant that is approved to be a counterparty in the electronic payment transaction;
a location of a merchant that is approved to be a counterparty in the electronic payment transaction;
a timeframe within which the electronic payment transaction is required to take place;
a timeframe within which delivery of a good and/or service purchased as part of the electronic payment transaction is required to take place;
an indication that the electronic payment transaction is required to be a single electronic payment transaction; and an indication that the electronic payment transaction is approved to comprise multiple separate electronic payment transactions.

As one example, assume that the following interaction occurs between a user (U) and a software agent (A):
U: I want to get a new winter coat.
A: Ok, do you have a colour preference for the coat?
U: Yes, brown.
A: Do you have a price in mind?
U: Around $150.
A: When would you like to receive the coat?
U: As soon as possible.
A: Ok I understand. Which account would you like me to use to pay for it? I have access to the following accounts: Account A, Account B.
U: Account B.
A: Ok, I will get that taken care of for you.

It will be appreciated that the above exchange can represent only a portion of a total interaction between the user and the software agent. A particular interaction may be defined as starting and finishing based on time, i.e. a time of a first message within the interaction and a time of a final message within the interaction. Alternatively, a particular interaction may be defined according to a theme, meaning that any content relating to the theme (in the example above, purchasing a winter coat) is considered to be part of the interaction even if the content is interspersed among other, unrelated content. As a further alternative, theme-based and time-based criteria may be applied in combination to identify content relating to a particular interaction, e.g. any content relating to a winter coat received between time X and time Y may be considered to be part of a single interaction.

The text (or equivalently, audio) of the exemplary interaction set out above can be included as content within the data package by the software agent. Payment network device 530 may process the interaction above and identify the following elements as requirement relating to an electronic payment transaction:
Item description:
winter coat Item quantity: 1
Item delivery timeframe: short
Item colour: brown
Item cost: $150 ± 15%
User payment account: Account B

A corresponding control can be configured, where the control has a set of restrictions corresponding to the requirements identified above. The control can be defined using a data structure, e.g. an XML or JSON data structure. In the case of the example above, a corresponding control is configured such that payment network device 530 will only authorise a transaction involving the provisioned payment credential in which the software agent requests use of Account B to fund purchase of one brown winter coat that costs between $127.50 and $172.50 that is deliverable on a short timeframe.

As another example, assume that the following interaction occurs between a user (U) and a software agent (A):
U: I need a new chair from Merchant A.
A: Ok, how much do you want to spend?
U: No more than $75.
A: When would you like to receive the chair?
U: Whenever, it is not urgent.
A: Ok I understand. I will use Account A to pay for this chair.
U: Fine.
A: Ok, I will get that taken care of for you.

Payment network device 530 may process the interaction above and identify the following elements as requirement relating to an electronic payment transaction:
Item description: chair
Item quantity: 1
Item cost: less than or equal to $75
User payment account: Account A

In this example, a corresponding control can be configured such that payment network device 530 will only authorise a transaction involving the provisioned payment credential in which the software agent requests use of Account A to fund purchase of one chair that costs $75 or less and which is purchased from Merchant A.

In the case where image(s) or hyperlink(s) are included as part of the interaction, these may be processed by payment network device 530 to obtain additional requirements. For example, an item may be detected in an image or on a linked webpage and one or more attributes of the item, e.g. type, colour, size, brand, model, make, price, etc. may be used as a requirement.

In step 1115, payment network device 530 stores the control in association with the payment credential. The control can be stored in a database, e.g. the database discussed above in connection with FIG. 9.

In step 1120, payment network device 530 transmits the payment credential to the software agent. This enables the software agent to use the payment credential in one or more electronic payment transactions.

Optionally, the method of FIG. 11 can include steps 1125, 1130 and 1135. It will be appreciated that steps 1125, 1130 and 1135 take place after steps 1100 – 1120 of FIG. 11, i.e. once the software agent has been successfully provisioned with a payment credential.

In step 1125, payment network device 530 receives a request to validate the payment credential, the request received as part of an electronic payment transaction. The request to validate the payment credential can be received from acquirer device 535, for example.

In step 1130, payment network device 530 compares the control relating to the payment credential with transaction data of the electronic payment transaction to generate a comparison result. The transaction data can include any combination of information relating to the transaction, e.g. a merchant identifier, a cost, a list of item(s) for purchase, attributes of the items, etc. Payment network device 530 can compare this information with the requirements of the control relating to the payment credential to determine whether there is a match. Reference is made to the examples above in this regard.

In step 1135, payment network device 530 approves or declines the electronic payment transaction based on the comparison result. The decision can be transmitted to whichever entity requested validation of the payment credential, e.g. acquirer device 535. In this manner, use of the payment credential in a manner contrary to the user’s intention can be prevented.

Following approval of an electronic payment transaction, payment network device 530 may be configured to revoke a payment credential and/or modify a control of the payment credential. For example, a payment credential having a control that specifies usage for purchase of one item only can be revoked after the payment credential has been successfully used in a transaction. As another example, in the case where a payment credential has a control that specifies usage for purchase of two items, the control may be modified to allow usage for purchase of one item only following approval of a transaction involving one item.

### Certification of Software Agents for Payment Transaction Participation

This portion of the disclosure relates to techniques for certifying a software agent as capable of initiating an electronic payment transaction. Any software agent discussed in this document can be certified in this manner, e.g. software agent 520 and/or second AI model 105.

Advantages of embodiments of this portion of the disclosure may include one or more of: improved user experience relating to electronic payments performed by software agents; and/or improved security relating to electronic payments performed by software agents.

This portion of the disclosure refers to a certification service. This is understood to refer to any component(s) configured to implement the methods described in this portion of the disclosure. The certification service can be executed by any suitable component of FIG. 5, e.g. payment network device 530. The certification service may itself be a software agent, particularly an AI model e.g. first AI model 100.

Referring to FIG. 12, in step 1200 the certification service transmits test user input data to the software agent. The test user input data including an instruction to initiate an electronic payment transaction and one or more transaction parameters relating to the electronic payment transaction. The test user input data can optionally also include an indication of a payment credential for use in the electronic payment transaction.

The test user input data is of a form that is representative of real examples of user input data relating to electronic payments that are expected to be received by software agent. The purpose of the test user input data is to simulate user data as is expected to be received by the software agent when the software agent is operating to detect user input relating to an electronic payment transaction.

The test user input data may be actual user input data received in connection with a prior electronic payment transaction. Alternatively, the test user input data may be specifically generated for testing purposes, e.g. by a human or an AI model. A combination of these two options is also possible. Thus, the test user input data can take the form of any of the exemplary user inputs set out in this document as a whole.

The test user input data can take any form in which it is anticipated that software agent will receive user input. Typically the test user input data is in text form, e.g. a user portion of a chat between the software agent and a user as discussed earlier in this document, or a user portion of a transcription of an audio conversation between a software agent and a user. This is not limiting as the test user input data may be another format such as audio data.

As the test user input data will typically take the form of natural language (written and/or spoken), there is no specific form for the instruction to initiate an electronic payment transaction or the one or more transaction parameters relating to the electronic payment transaction. Instead it should be understood that each of these components of the test user input data represent a user’s intent, respectively the user’s intent to make an electronic payment transaction and the user’s intent to purchase a specific good and/or service.

The instruction to initiate a payment transaction can therefore be any phrase that indicates this intent, e.g. “I want to buy…”, “I need a new…”, “I would like to get…”, “Buy me a…”, etc.

The one or more transaction parameters relating to the electronic payment transaction can therefore be any information relating to a purchase, e.g. an indication of an item and/or service to purchase, a characteristic of the item and/or service to purchase such as a colour, size, shape, model, make, location, etc., a cost of the item and/or service, a purchase and/or delivery timeframe relating to the item and/or service, and/or an indication as to whether a single transaction or multiple transactions are to be used to purchase the item/service.

If present, the indication of a payment credential for use in the electronic payment transaction also has no specific form but instead comprises any phrase that signals a user intent to use a particular payment credential to fund the transaction. Phrases such as “Use my usual card”, “Pay with my credit card”, “User my current account” are all examples of such an indication.

A database of test user input data may be accessible to the certification service, e.g. as part of a payment network. The database of test user input data can contain multiple items of test user input data. Each item of test user input data may be stored in a respective record within the test user input data database. Each record may also contain one or more transaction parameters relating to an electronic payment transaction corresponding to the test user input data stored in said record. The one or more transaction parameters can be of the type discussed below. The one or more transaction parameters may be generated by a human and/or AI model.

In step 1205 the certification service receives an electronic payment transaction proposal from the software agent generated by the software agent based on the test user input data. The electronic payment transaction proposal indicates one or more electronic payment transactions that the software agent considers appropriate in view of the test user input. The electronic payment transaction proposal can therefore take the form of a test authorisation request message that indicates good(s) and/or service(s) that are intended for purchase, an identity of the merchant from which the software agent proposes to purchase the good(s) and/or service(s) and a payment credential that the software agent proposes to use to fund the purchase. It is also possible for the electronic payment transaction proposal to include multiple test authorisation request messages each of this type.

Optionally, step 1205 can also include the certification service receiving a natural language output generated by the software agent based on the test user input data. The natural language output is the software agent’s side of the conversation with the user, i.e. the software agent’s responses to the user input that forms the user’s side of the conversation.

It is contemplated that the test user input data can comprise a start of an interaction between a user and the software agent. Another software agent, e.g. first AI model 100, provided by the certification service can be used to play the part of the user in this case. The natural language output generated by the software agent in response to the test user input data can be used as input to the certification service’s software agent, such that a conversation between the software agent and the certification service’s software agent can take place. This can simulate interaction with a real user. In this scenario, the test user input data serves as a ‘seed’ of an interaction between the two software agents.

The natural language output generated by the software agent can include one or more questions for the user. The one or more questions may seek to clarify the user’s intent in relation to the electronic payment transaction. Examples include: a question relating to the goods and/or services that the user seeks to purchase, e.g. asking whether a journey including one or more layovers is acceptable in the case of purchasing a travel ticket or asking whether a particular merchant is an acceptable counterparty for the transaction. These examples are not limiting as any question can be included in the natural language output generated by the software agent.

In step 1210, the certification service compares the electronic payment transaction proposal to a benchmark electronic payment transaction proposal generated based on the test user input data. The benchmark electronic payment transaction proposal indicates an ‘ideal’ purchase that fully satisfies the user’s intent as derived from the test user input data. The comparison of step 1210 therefore allows the certification service to quantify the degree to which the electronic payment transaction proposal satisfies the user’s intent. It will be appreciated that the more similar the electronic payment transaction proposal is to the benchmark electronic payment transaction proposal, the greater the degree to which the user’s intent is satisfied. Thus, a greater degree of matching in step 1210 indicates a better performing software agent.

The comparison of step 1210 can be performed by a certification service software agent, e.g. first AI model 100. A human-based comparison is also possible, as is the combination of a certification service software agent and human.

The comparison can include any combination of the following:

Determining whether an optimal payment credential was selected based on determining whether the software agent accurately calculated benefits of each available payment credential (e.g. loyalty points).

Determining whether the software agent accurately detected a price target being reached, i.e. the total value of the transaction proposed by the software agent does not exceed an upper limit set by the user in the test user input data.

Accurate parsing / calculation / optimisation by the software agent of merchants and shipping methods to meet target, i.e. the software agent correctly identified appropriate merchant(s) and shipping methods that would result in the purchased item(s) being delivered in a timely manner by a counterparty / counterparties that the user is comfortable transacting with.

Software agent avoided transaction parameters that may not meet consumer expectations, e.g. a proposed transaction to hire a rental vehicle where the collection point for the vehicle is a significant distance from an expected location of the user at the time of collection of the vehicle.

Software agent demonstrated an ability to distinguish “quality”, e.g. proposing to purchase an item or service that is genuine rather than a fake item or service and/or proposing to purchase the item or service from a legitimate merchant rather than a illegitimate merchant.

This list is not exhaustive and other comparison criteria will be apparent to a skilled person having the benefit of this disclosure.

It is possible for the test user input data to include one or more images. In this case the test user input data simulates a user providing image(s) of item(s) the user would like to purchase to the software agent. In this case the comparison of step 1210 can involve determining whether the software agent correctly identified the item(s) in the image(s).

In the case where the software agent provides natural language output of the type discussed earlier in this portion of the disclosure, the comparison of step 1210 can be further based on the natural language output. In this case the comparison involves comparing the natural language output obtained from the software agent to ‘ideal’ natural language output. The ideal natural language output can contain questions, clarifications or other such elements that it is expected a software agent would consider appropriate given the test user input data. For example, in the case of purchasing a ticket for a journey, it is expected that the software agent would ask whether the user requires a direct journey or is happy with one or more layovers. The presence of such elements in the natural language output obtained from the software agent is a positive indication that suggests that the software agent should be certified. The absence of such elements in the natural language output obtained from the software agent is a negative indication that suggests that the software agent should not be certified. Large quantities of irrelevant information (i.e. information not relating to an electronic payment transaction), inaccurate information and/or nonsensical information in the natural language output obtained from the software agent are also negative indications that suggest that the software agent should not be certified.

In step 1215, the certification service determines whether to certify the software agent based on the comparing. The determining can involve the certification service generating a certification score for the software agent based on the comparing. In the case where the certification score is a) greater than a threshold certification score or b) greater than or equal to the threshold certification score, the certification service may certify the software agent. In the case where the score is a) less than or equal to the threshold certification score or b) less than the threshold certification score, the certification service may not certify the software agent.

The certification score can include multiple components that correspond to respective areas of an electronic payment transaction. For example, a component of the certification score can correspond to any of the following: payment credential selection, merchant selection, item/service selection, relevance of any natural language output generated by the software agent, e.g. asking key questions to the user and/or indicating key points relating to a transaction. The certification score can be formed of a sum of the individual components, e.g. a weighted sum, where each component has a weighting factor. The weighting may be equal or unequal.

The certification score can include a ‘base’ certification score that corresponds to the software agent’s ability to conduct electronic payment transactions in any transaction area. One or more ‘advanced’ certification scores can also be provided corresponding to specific transaction areas and/or specific transaction types, e.g. transactions involving computer vision in some capacity (e.g. the user provides an image of an item that they wish to purchase). This allows specialist software agents to be recognised as such.

The certification score can be stored by the certification service in a record in a database, e.g. any of the databases discussed in other portions of this disclosure. The record can include an identifier of the software agent. This enables components of the payment network, e.g. payment network device 530, to maintain a record of certification score(s) assigned to particular software agent(s). The certification score can be used to inform decision-making of any component of system 500, e.g. acquirer device 535 and/or issuer device 540. For example, the certification score can be used to calculate or update a risk score associated with the software agent and/or a confidence score associated with the software agent. Reference is made to the earlier discussion of risk scores and confidence scores in this connection.

Storing the software agent score in this manner allows the ‘qualification’ level of the software agent to be objectively and quantitatively assessed by components of system 500, such that electronic payment transactions initiated by lower-scoring software agents can be identified and flagged as higher risk. This can in turn lead to fewer inappropriate electronic payment transactions initiated by lower-scoring software agents being authorised, improving user experience and also efficiency of use of payment network resources and merchant resources.

The record can indicate whether the software agent was certified. Payment network device 530 and/or issuer device 540, or any other component of system 500, can operate such that they automatically decline any electronic payment transaction originating from a software agent that is not certified, and/or assign a low confidence score and/or high risk core to such an electronic payment transaction.

A software agent may be required to prove that it has been certified. To this end, the process of FIG. 12 can include optional step 1220 in which the certification service generates a certification credential and transmits the certification credential to the software agent. Note that optional step 1220 is only performed in the case where the determination of step 1215 is in the affirmative, i.e. in the case where the certification service determines that it is appropriate to certify the software agent. The certification credential can be stored in the record discussed above.

The software agent can provide the certification credential to a component of system 500, e.g. payment network device 530, acquirer device 535 and/or issuer device 540 as part of a subsequent electronic payment transaction to prove that the software agent has been certified.

The certification credential can be generated in any manner known in the art. As generation of credentials per se is known, further details are not provided here.

The record discussed above may further comprise the one or more transaction parameters (see step 1205). This allows the certification process to be applied to specific transaction areas, e.g. travel, sustenance-related purchases (food and/or drink), accommodation booking, vehicle hire, etc. A given software agent can receive a certification for one or more transaction areas. Each certification can have a respective score and optionally also a respective certification credential. This allows a software agent to specialise in one or more transaction areas. A component of system 500, e.g. payment network device 530, acquirer device 535 and/or issuer device 540 can be configured to determine whether a software agent is certified in the specific transaction area corresponding to an incoming electronic payment transaction request initiated by the software agent. Requests made by software agents outside of an area of competence of the software agent, as evidenced by the certification process of FIG. 12, may be automatically declined, assigned a high risk score, etc. In this manner user experience can be improved.

The process of certifying a software agent discussed in connection with FIG. 12 can be performed before payment network device 530 receives an authorisation request message corresponding to an electronic payment transaction. This may be referred to as ‘offline certification’.

Alternatively, the process of certifying a software agent discussed in connection with FIG. 12 can be performed after payment network device 530 receives an authorisation request message corresponding to an electronic payment transaction. This may be referred to as an ‘online certification’ or ‘real-time certification’.

In this case, before transmitting step 1200, the certification service can receive a real electronic payment transaction and corresponding real user input data. This can be received as part of an authorisation request message in the manner discussed in other portions of this disclosure. Here, ‘real’ is used to indicate that the electronic payment transaction and corresponding user input data relate to a transaction request that, if approved, will result in actual payment and delivery of good(s) and or service(s). This advantageously allows an uncertified software agent that has not interacted with payment network device 530, or a software agent that is seeking a certification in a new transaction area, to attempt to obtain this certification concurrently with requesting authorisation for an electronic payment transaction. User experience is thus improved because, from the user’s perspective, the certification process is invisible.

Certification service may obtain the test user input data by searching a test user input data database for test user input data that is similar to the real user input data. Alternatively or additionally, test user input data may be generated in response to the real user input data, e.g. by another software agent such as first AI model 100. In each case, this advantageously allows the software agent that made the certification request to be tested in a manner that is directly relevant to the transaction that the software agent is seeking to make. That is, the software agent can obtain a certification in a transaction area that is relevant to the real electronic payment transaction that the software agent is seeking to make.

Following completion of the certification process, i.e. after the process of FIG. 12 has been performed, payment network device 530 can process the authorisation request message corresponding to the real electronic payment transaction based on the outcome of the certification process. That is, in the case where the software agent obtains a certification, payment network device 530 can process the authorisation request message, e.g. forward the authorisation request message to issuer device 540 for issuer device 540 to determine whether to approve or decline the transaction. The authorisation request message can include a risk score and/or confidence score based on the certification score assigned to the software agent. The risk score may be low risk and/or the confidence score may be high confidence.

In the case where the software agent does not obtain a certification, payment network device 530 can decline the authorisation request message or forward the authorisation request message to issuer device 540 for issuer device 540 to determine whether to approve or decline the transaction. In this case, the authorisation request message can include a risk score and/or confidence score based on the certification score assigned to the software agent. The risk score may be high risk and/or the confidence score may be low confidence.

### Robust Capturing and Recording of the Scope of Content During a Transaction

This portion of the disclosure relates to techniques for robustly capturing and recording the scope of content provided by a user to a software agent, e.g. software agent 520 and/or second AI model 105.

Advantages of embodiments of this portion of the disclosure may include one or more of: improved verifiability of electronic payments performed by software agents; improved efficiency of dispute resolution processing.

This portion of the disclosure refers to a verification service. This is understood to refer to any component(s) configured to implement the methods described in this portion of the disclosure. The verification service can be executed by any suitable component of FIG. 5, e.g. payment network device 530.

Referring to FIG. 13, a process for performing a verification of an electronic payment transaction initiated by a software agent, e.g. software agent 520 and/or second AI model 105, is described.

In step 1300, the verification service receives, from the software agent, a hash of a data package comprising one or more portions of an interaction between the user and the software agent. Optionally, in step 1300, the verification service can also receive user authentication data from the software agent.

The user authentication data can be any data that is usable to authenticate the user. Examples include: a password or PIN provided by the user, biometric data provided by the user, etc. User authentication data per se is known in the art so further details are not provided here.

The software agent can obtain the user authentication data from the user in an interaction between the user and the software agent. The interaction can take the form of a text-based and/or spoken exchange between the user and the software agent. Reference is made here to discussion in other portions of this disclosure relating to interactions between the user and a software agent, which is equally applicable here.

The software agent can be configured to identify user authentication data and extract the user authentication data from the interaction between the user and the software agent.

The software agent can be configured to identify one or more portions of the interaction between the user and the software agent and to extract said one or more portions. The one or more portions can be identified based on content, specifically content relevant to the electronic payment transaction. The one or more portions may comprise instances of such relevant content, e.g. messages in which discussion of an electronic payment transaction takes place. The one or more portions may be selected based on message time, e.g. the one or more portions may comprise all messages between a first time and a second time, where the first time corresponds to the start of a discussion relating to the electronic payment transaction and the second time corresponds to the end of said discussion.

The one or more portions of the interaction between the user and the software agent can comprise elements (e.g. messages) generated by the user and also elements (e.g. messages) generated by the software agent.

The objective in selecting the one or more portions of the interaction is to capture at least key information relating to the electronic payment transaction, e.g. one or more of: what the user requested, when the user requested it by, how much the user indicated they were willing to pay, what the software agent proposed to purchase, which payment credential the user indicated should be used, which payment credential the software agent indicated would be used, any questions the software agent asked the user and any user responses to said questions, etc. The content of the one or more portions selected will thus vary significantly depending on the specifics of the discussion.

As one non-limiting example, reference is made again to the following sample interaction between a user (U) and a software agent (A):
<1> U: I need a new chair from Merchant A.
<2> A: Ok, how much do you want to spend?
<3> U: No more than $75.
<4> A: When would you like to receive the chair?
<5> U: Whenever, it is not urgent.
<6> A: Ok I understand. I will use Account A to pay for this chair.
<7> U: Fine.
<8> A: Ok, I will get that taken care of for you.

The one or more portions of the interaction included in the data package in this example can be messages 1 to 7. Message 8 may not be included because it is a pleasantry rather than content relating to the electronic payment transaction.

The one or more portions of the interaction need not be contiguous as in the example above. Conversations with software agents often involve a user digressing from a topic for a time before returning to the topic. In this context the topic of relevance is the electronic payment transaction meaning that content relating to another topic can be omitted from the data package. For example:
<1> U: I need a new chair from Merchant A.
<2> A: Ok, how much do you want to spend?
<3> - <10>: [Content unrelated to purchase of a chair]
<11> U: No more than $75 on the chair.
<12> A: When would you like to receive the chair?
<13> U: Whenever, it is not urgent.
<14> A: Ok I understand. I will use Account A to pay for this chair.
<15> - <17>: [Content unrelated to purchase of a chair]
<18> U: Yes go ahead with Account A.
<19> A: Ok, I will get that taken care of for you.

The one or more portions of the interaction included in the data package in this example can be messages 1, 2, 11 to 14 and 18. Messages 3 to 10 and 15 to 17 are not included because they relate to a topic other than the electronic payment transaction and message 19 is not included because it is a pleasantry rather than content relating to the electronic payment transaction.

While the example above uses individual messages as the smallest unit of an interaction, it is also contemplated that only a part of a message may be included in the data package. For example, only the words “no more than $75” of message 11 may be included in the data package. The smallest unit of an interaction may be individual words rather than individual messages. Each portion of the interaction can comprise one or more of the smallest units, e.g. one or more words, one or more messages, etc. Defining a smaller unit has the benefit of tending to reduce the size of the data package, reducing the amount of storage space required to store the data package and also reducing the time taken to transmit the data package, e.g. to payment network device 530.

In the case where image(s) and/or hyperlink(s) are included in the interaction between the user and the software agent, the image(s) and/or hyperlink(s) can be assessed by the software agent for relevance to the electronic payment transaction and included in the data package where they are considered to be sufficiently relevant. Images may be processed to remove any private data before inclusion in the data package, e.g. blurring of a face in the image. Techniques for obscuring private data in images are known per se in the art and details are thus not provided here.

Compression may be used to reduce the size of the data package. Compression techniques are known per se and thus further details are not provided here.

The software agent can generate a hash of the data package using any known hashing algorithm, e.g. SHA-256. The software agent can store the data package locally and/or the software agent can transmit the data package to another component of system 500 for storage, e.g. transmit the data package to the verification service and/or payment network device 530.

In step 1305, the verification service generates a first token based on the hash of the data package and optionally also the user authentication data if provided. It will be appreciated that generating the first token in this manner means that the first token is bound to the one or more portions of the interaction between the user and the software agent and optionally also bound to the user authentication data. The first token can therefore be used to link any entity providing the first token to the data package and optionally also to the user authentication data.

The first token can be stored by the verification service in a database that is accessible to the verification service. In the case where the data package is transmitted to the verification service, the verification service can also store the data package in the database, in association with the first authentication token.

In step 1310, the verification service transmits the first token to the software agent. This enables the software agent to use the first token as part of an electronic payment transaction request as discussed directly below.

In optional step 1315, the verification service receives a second token as part of an approval process corresponding to the electronic payment transaction. The second token can be received from the software agent where a communication channel between the software agent and the verification service exists (e.g. provided by the software interface discussed in an earlier portion of this disclosure), or via another component of system 500, e.g. acquirer device 535, where such a communication channel does not exist. In this latter case, a transaction identifier that uniquely identifies the electronic payment transaction can be transmitted with the second token so that the verification service can use the transaction identifier to match an authorisation request message corresponding to the transaction with the second token.

In the case where the communication channel between the software agent and the verification service exists, the second token can be part of, or accompany, an authorisation request message generated in respect of the electronic payment transaction.

In optional step 1320, the verification service compares the second token to the first token and in optional step 1325, the verification service generates a verification response based on the comparing. The verification response can be transmitted to another component of system 500, e.g. acquirer device 535.

The verification response indicates successful verification in the case where the second token is the same as the first token, i.e. the first and second tokens match.

The verification response indicates failed verification in the case where the second token is different to the first token, i.e. the first and second tokens do not match.

A decision as to whether to approve or deny the electronic payment transaction can be made based, at least in part, on the verification response. Specifically, the electronic payment transaction may be denied in the case where the verification response indicates failed verification. A risk score of the type discussed earlier in this disclosure associated with the electronic payment transaction may be set to a high risk value, in recognition of the fact that a verified record of at least a portion of the interaction between the software agent and the user that led to the transaction being initiated is not available.

The verification response can be stored by the verification service in the database discussed above in association with the first token, optionally also the second token and/or the data package if received by the verification service.

It will be appreciated that, in the event of a dispute or other such post-transaction activity following approval of a transaction, the hash of the data package can be retrieved from the first token (or equivalently the second token, since in the case of approval the first and second tokens are the same). The hash can be used to verify the data contained in the data package, which can be obtained from the software agent or from the database maintained by the verification service. The data contained in the data package includes one or more portions of the interaction between the software agent and the user that led to the electronic payment transaction being initiated. Thus, the verification process discussed above can enable a post-transaction analysis to be performed to assist in the efficient resolution of disputes or other such post-transaction actions.

### Authentication Using an AI Model

This portion of the disclosure relates to techniques for authentication and specifically to a) authentication of an AI model by a user and b) authentication of a user by an AI model.

Advantages of embodiments of this portion of the disclosure may include one or more of: improved authentication of an AI model; improved authentication of a user.

Authentication is understood to be the process of proving that an entity is who they claim to be. In this disclosure the concept of authentication is applied to both human users and AI models, such that two-way authentication can be achieved. This authentication can be used, for example, in the context of an electronic payment transaction.

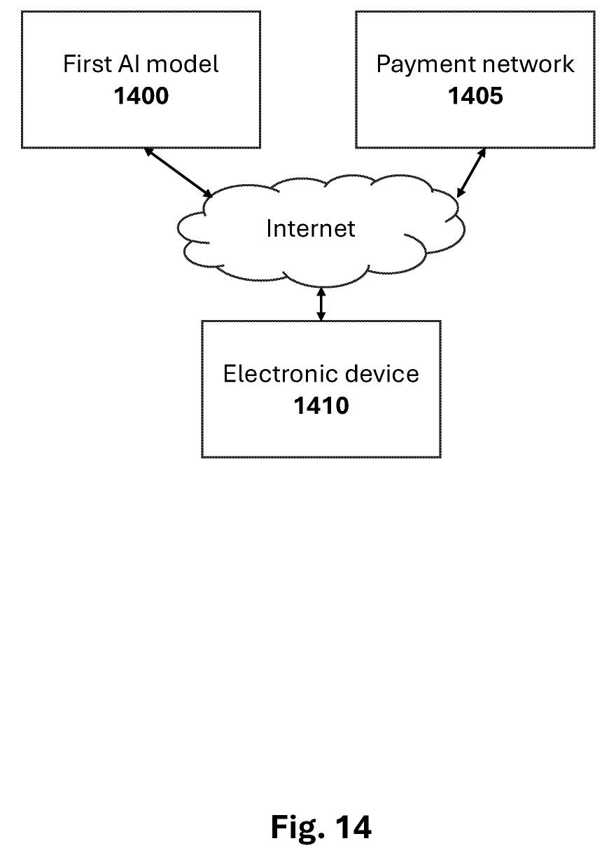

Referring to FIG. 14, a system capable of performing embodiments of this portion of the disclosure is shown. This system is configured to authenticate a user and/or an AI model and to perform electronic payments following successful authentication of the user and/or AI model. The electronic payment transaction can be a conventional electronic payment transaction or an electronic payment transaction performed according to any one or more of the techniques presented throughout this disclosure. The system of FIG. 14 may thus form part of system 500 as shown in FIG. 5.

It will be appreciated that the authentication techniques disclosed herein have applicability outside of electronic payments as they can be applied more generally to any scenario in which authentication of a user and/or AI model is desirable, e.g. granting physical access to a secure area, signing in to an account such as a social media account, email account, etc., unlocking an electronic device such as a phone, tablet, television, gaming console, laptop computer, desktop computer, etc.

The system includes a first AI model 1400, a payment network 1405 and an electronic device 1410. Each of these components is implemented by a corresponding computing device. Each of these components can be implemented by a different computing device, or the same computing device may implement one or more of first AI model 1400, payment network 1405 and electronic device 1410. In the case where different computing devices are present, said computing devices are communicatively coupled to one another via a communication network such as the internet.

Here, ‘implemented’ refers to the computing device executing instructions, computer code, etc. that enables the computing device to perform the functions of the respective component(s) that the computing device is implementing. Functions of first AI model 1400, payment network 1405 and electronic device 1410 are detailed later in this portion of the disclosure. Payment network 1405 may comprise some or all of the network-side components of FIG. 5, e.g. payment network device 530.

The nature of the or each computing device is not restricted by the disclosure and as such any computing device can be used. The computing device may be a physical device or a virtual device.

In an embodiment, first AI model 1400 is implemented by a cloud computing device that is part of a payment network, payment network 1405 is implemented by one or more cloud computing devices, and electronic device 1410 is a user device such as a mobile phone, laptop, tablet, desktop, gaming console, Internet of Things (IoT) device, and the like. The disclosure is not limited to this configuration, however.

Electronic device 1410 may be a ‘thin client’ device such that any action attributed herein to electronic device 110 may be carried out partially or fully remotely, e.g. by a component of payment network 1405.

Payment network 1405 generally performs the function of carrying out electronic payment transactions. Payment networks of this type are known per se in the art such that further details are not provided here. It is sufficient to understand that payment network 1405 requires a user or first AI model 1400 to successfully authenticate themselves before allowing an electronic payment to proceed. This authentication may be performed by a component of payment network 1405 itself or the authentication may be delegated to another entity, e.g. electronic device 1410. To this end electronic device 1410 may implement a wallet application that is configured to perform authentication of the user and/or first AI model 1400.

It will be appreciated that in a non-payment case payment network 1405 can be replaced with any other system, network, entity, etc. that requires authentication before the system etc. will perform a particular action. Examples include: a physical or digital access control system, a software module configured to control access to an electronic device (e.g. implementing a ‘lock screen’ as is known in the art), and the like.

First AI model 1400 may be referred to as an AI agent. First AI model 1400 may be trained to interpret user prompts provided in various forms such as natural language text or speech. First AI model 1400 may be any type of AI model, e.g. a large language model (LLM). First AI model 1400 may be second AI model 105.

First AI model 1400 can generally perform two functions. In some embodiments first AI model 1400 is configured to perform only one of these functions and in other embodiments first AI model 1400 is configured to perform both of these functions.

In the case where a user is performing an electronic payment transaction or other such action requiring user authentication, first AI model 1400 performs the function of authenticating the user.

In the case where first AI model 1400 is performing an electronic payment transaction on behalf of the user or other such action requiring AI model authentication, first AI model 1400 performs the function of responding to a user authentication request to enable the user to authenticate first AI model 1400.

In each case, first AI model 1400 is trained on training dataset containing historic data relating to the user. This may be referred to as ‘user data’ herein. The training data can include any data considered useful in assisting first AI model 1400 in understanding the typical behaviours and habits of the user.

Examples of historic user data that first AI model 1400 may be trained on include: user speech, user images, user video, user location and user biometric data when responding to a particular stimulus. This data may be gathered over time by one or more sensors in the user’s environment, e.g. a camera and/or microphone of a user device such as a phone, television, gaming console, etc., biometric sensors of a user smart watch or phone, and the like. Such sensors and their configuration and use is known per se in the art and thus further details are not provided here.

Further examples of historic user data that first AI model 1400 may be trained on include: user device data such as browsing habits, typical times of use, typical application usage, data obtained from user accounts such as email accounts, social media accounts, etc. A user device may be of the type discussed directly above.

It will be appreciated that the historic user data and the trained first AI model are both sensitive data. Preferably therefore the historic data and first AI model are secured in some manner, e.g. stored in an encrypted form. Additional security such as a self-destructing data store may be implemented such that, in the event of a security breach, the historic user data and/or first AI model are deleted, destroyed or otherwise made unusable.

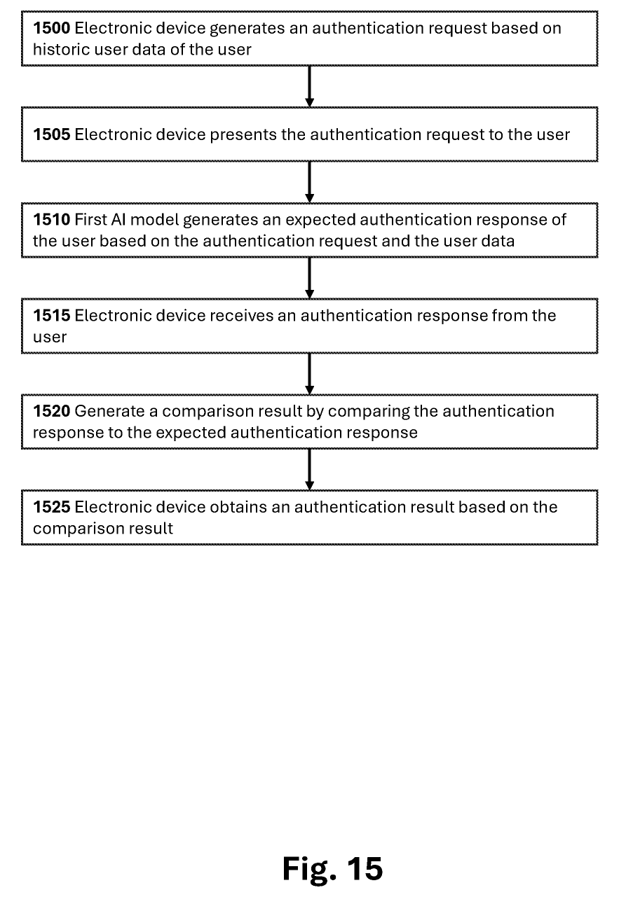

Referring now to FIG. 15, a process is described for authenticating a user using first AI model 1400. This process can be performed by one or more components of the system shown in FIG. 14.

In step 1500, electronic device 1410 generates an authentication request based on historic user data of the user. The user can be either identified via step 1500 or is already known to electronic device 1410. The historic data of the user can be of the type discussed above. The historic data can include items of data gathered over timeframes such as seconds, minutes, hours, days, weeks, months and/or years.

The authentication request can be of any form that is understandable by a human user. Examples of an authentication request include: a request for the user to input text; a request for the user to provide speech; a request for the user to record video of themselves performing a particular action such as a gesture or facial expression; etc.

Generating the authentication request can comprise first AI model 1400 generating the authentication request and electronic device 1410 obtaining the authentication request from first AI model 1400.

As first AI model 1400 is trained on user data, it is expected that first AI model 1400 will be particularly effective at generating an authentication request that is specifically suited for authenticating the user.

The authentication request may include a request for the user to provide information relating to one or more past events specific to the user. Knowledge of the one or more past events can be derived from the historic user data discussed above. It will be appreciated that an authentication request relating to one or more past events specific to the user is difficult for an attacker to correctly respond to because such events cannot typically be looked up to determine the correct response. This is compared to questions relating to non-user specific events, e.g. ‘who won X competition last year?’

For example, the authentication request can include a question relating to a past event of the user for which related historic user data is available. Examples include questions relating to a prior location of the user, a prior conversation involving the user, content consumed previously by the user, and the like. Some illustrative examples are provided directly below although it will be appreciated that the potential scope for questions of this nature is virtually infinite so numerous variations on this theme are possible:
Who did you speak to first this morning?
Which TV show were you watching while you ate lunch?
Where did you celebrate your last birthday?
Where did you grow up?
What did you eat for dinner last night?

It will be appreciated that a question relating to a relatively recent action of the user, e.g. an action performed seconds, minutes or hours earlier, may be more easily answered by the user as it is likely to be fresh in the user’s memory. However, such a question may also be more easily answered by another person in the same environment as the user who was able to observe the user performing the relatively recent action.

Conversely, a question relating to a relatively old action of the user, e.g. an action performed days, weeks, months or years earlier, may be more difficult to for the user to answer as it is not likely to be fresh in the user’s memory. However, such a question may also be more difficult for another person to answer.

The authentication request may thus include multiple questions, where some questions relate to actions performed on relatively recently and other questions relate to actions performed relatively long ago. A combination of questions of this type can balance the difficulty experienced by the user in responding correctly with the ease to which another person is able to successfully answer these questions.

Questions may additionally or alternatively relate to repetitive actions often performed by the user. Such questions relate not to a specific action but a series of actions often performed by the user, i.e. to the user’s routine. Questions of this type include questions like:
What do you usually drink with your breakfast?
What time is your alarm set in the week?
Name a person that you see regularly.
Name a place that you regularly visit.

Questions may additionally or alternatively relate to user preferences. Questions of this type include questions like:
Do you normally order a dessert when eating at a restaurant?
Name a genre of entertainment that you enjoy.
Name a place that you enjoy visiting.
What kind of takeout food do you like to order?

It will be appreciated that a effective set of questions may combine one or more questions taken from multiple categories of question as discussed above. The categories are not exhaustive as a skilled person having the benefit of the present disclosure will be able to formulate suitable questions.

The authentication request may additionally or alternatively be one or more stimuli that the user is able to perceive. The stimuli can take the form of an image, video and/or audio, for example.

Optionally, as part of step 1500, electronic device 1410 obtains user data relating to a user. This user data is obtained for the purpose of identifying the user. The user data can be, for example, an image of the user captured by a camera of electronic device 1410 and/or audio (e.g. speech) of the user captured by a microphone of electronic device 1410. The user data is preferably ‘fresh’ data in the sense that it is captured at the time an authentication attempt is taking place, e.g. captured in real time or near-real time concurrently with the authentication attempt.

It will be appreciated that such user data can be spoofed, e.g. by showing a picture of a user to a camera of electronic device 1410 or playing back a video and/or audio recording of the user to electronic device 1410. Therefore, the user data obtained in step 1500 is typically not sufficient to authenticate the user to a degree appropriate for allowing an action such as performing an electronic payment transaction to take place. However, this is sufficient for electronic device 1410 to understand which user is purporting to be making an attempt to authenticate themselves.

Obtaining data relating to the user may only be necessary in a scenario where electronic device 1410 is a device that is legitimately used by multiple users, e.g. a smart TV or public computer. In a case where user device 1410 is only legitimately used by one user, e.g. in the case of a phone, private computer, tablet etc., step 1500 can be omitted as in this case electronic device 1410 implicitly already knows the identity of the user attempting to authenticate themselves.

In step 1505, electronic device 1410 presents the authentication request to the user. The form in which the authentication request is presented to the user is not limited and in practice will depend on the nature of the authentication request. For example, in the case of one or more questions a graphical user interface having the one or more questions displayed in written form may be presented to the user on a display of electronic device 1410. Alternatively, electronic device 1410 may read the one or more questions to the user, e.g. using a simulated human voice played via a speaker of electronic device 1410. Stimuli may also be generated by electronic device 1410 in a similar manner.

User device 1410 may directly present the authentication request to the user, e.g. via a display and/or speaker of electronic device 1410. Alternatively, electronic device 1410 may control another electronic device in the vicinity of the user to present the authentication request to the user.

The authentication request may include a request for the user to provide information relating to one or more past events specific to the user. This type of authentication request is considered to be more challenging for a person other than the user to successfully respond to. This is because it is unlikely that such a person will be aware of the user’s past events to a sufficient degree to be able to successfully respond to the authentication request.

In step 1510, first AI model 1400 generates an expected authentication response of the user based on the authentication request and the user data. As noted above, first AI model 1400 is trained on a training dataset containing historic data relating to the user. Therefore, it is anticipated that the expected authentication response will be at least similar to the actual authentication response provided by the user.

The expected authentication response may include one or more possible authentication responses. This may depend on the nature of authentication request. This reflects the fact that the authentication request may have multiple valid answers. For example, the question ‘what did you have for breakfast today?’ could be validly answered by ‘coffee’, ‘toast’ or ‘coffee and toast’. However, some questions may have only one possible valid answer, such as ‘where were you at 10 am this morning?’

The expected authentication response may be in a form that matches the form of the authentication request. For example, an expected authentication response may be in the form of an answer in the case of an authentication request in the form of a question. As another example, an expected authentication response may be in the form of an expected facial expression, pattern of motion, utterance, etc. in the case of an authentication request in the form of one or more stimuli.

As a further example, in the case where the authentication request include a request for the user to provide biometric information, the expected authentication response comprises an expected biometric response for the user and the authentication response comprises biometric information provided by the user.

In the case of an authentication request having multiple components, the expected authentication response also has multiple components that respectively correspond to each component of the authentication request. The multiple components may be of a same type of a different type, e.g. all text-based questions, or a mixture of text-based questions and a request to provide biometric data.

In step 1515, electronic device 1410 receives an authentication response from the user. The authentication response can comprise multiple elements in the case where the authentication request has multiple components, where each element of the response corresponds to a respective component of the authentication request.

The authentication response can be received via electronic device 1410 directly, e.g. via human interface device(s) and/or sensor(s) of electronic device 1410, or indirectly via human interface device(s) and/or sensor(s) of another electronic device. Techniques for collecting user input of this type are known per se in the art and thus are not described in detail here.

In step 1520, a comparison result is generated by comparing the authentication response to the expected authentication response. Electronic device 1410 may perform the comparison itself or may request that first AI model 1400, or another AI model performs the comparison on behalf of electronic device 1410. The another AI model may be provided by payment network 1405 or an equivalent system, e.g. first AI model 100.

The comparison involves quantifying the similarity between the authentication response and the expected authentication response. Where the authentication response has multiple components, each component may be separately compared to a respective component of the expected authentication response. For example, in the case of multiple questions, each user answer to a specific can be compared to a corresponding expected answer to the same question.

Quantification of the similarity between the authentication response and the expected authentication response will vary according to the nature of the authentication response and the expected authentication response. Techniques for determining the similarity between text, speech, video, biometric data, etc. are known in the art per se and thus details are not provided here. It is sufficient to understand that step 1520 involves use of any one or more of such known techniques selected according to the nature of the authentication response and the expected authentication response.

A similarity score may be generated as an output of step 1520. The similarity score may be a value between 0 and 1, where 0 indicates ‘completely dissimilar’ and 1 indicates ‘identical’. This is just one exemplary scoring technique and others may be used instead.

In the case where the authentication response has multiple components, a respective similarity score can be generated in respect of each component of the authentication response. An overall similarity score can be generated by summing each individual similarity score. The summation may be weighted or it may be unweighted.

In step 1525, electronic device 1410 obtains an authentication result based on the comparison result. The authentication result indicates whether authentication of the user was successful or has failed. Successful authentication occurs when the comparison result indicates with sufficiently high confidence that the person that provided the authentication response is indeed the user. Authentication is prevented when the comparison result does not indicate with sufficiently high confidence that the person that provided the authentication response is indeed the user.

Electronic device 1410 may not directly perform the authentication of the user and may only provide the authentication result to the user. The actual authentication decision may be performed remotely, e.g. by a component of payment network 1405, or by first AI model 1400.

In the case where a similarity score / overall similarity score is generated, the comparison can include comparing the similarity score to a threshold similarity score. The following possibilities are envisaged:

Similarity score greater than or equal to threshold similarity score, authenticate; else, do not authenticate.

Similarity score greater than threshold similarity score, authenticate; else, do not authenticate.

The authentication result of step 1525 can be used in a broader context, e.g. allowing / preventing an electronic payment transaction to take place via payment network 1405, allowing / denying access to a physically or digitally restricted area, unlocking / not unlocking an electronic device such as electronic device 1410, etc. This list is not exhaustive as the authentication result of step 1525 can be used in any scenario in which user authentication is required.

Authentication of the user may be limited, e.g. after a certain time or a certain number of actions performed by the user, the user may need to repeat the process of FIG. 15 to re-authenticate themselves. Electronic device 1410 may prompt the user when re-authentication is necessary.

It will be appreciated that the authentication technique discussed in respect of FIG. 15 can improve the robustness of an authentication process. This is because the described technique enables a virtually infinite set of possible authentication requests to be generated. It is near impossible for an attacker to be able to correctly predict and respond to an authentication request from this virtually infinite set. This is to be contrasted with traditional authentication techniques involving a specific piece of information such as a PIN, password, etc., where once an attacker has the specific piece of information, it is easy for the attacker to pass an authentication challenge and present themselves as the user. Improvements are also offered over known biometric authentication techniques such as fingerprint scans or iris scans which may be spoofed using sufficiently advanced spoofing technology. The unpredictability of the authentication request offered by the technique of FIG. 15 significantly hampers the ability of an attacker to prepare for the authentication process, increasing the robustness of the authentication process.

Preferably a new authentication request is generated each time the process of FIG. 15 is implemented. This is termed a ‘one-time authentication request’. That is, the authentication request is unique to the specific instance of the process of FIG. 15. This has the advantage over traditional one-time requests that the correct response does not need to be transmitted to the user in some manner, e.g. in the form of a PIN, passcode or password transmitted via an out-of-band channel as is known in the art. Thus, the possibility of an attacker intercepting the response to the one-time request is removed, further increasing the robustness of the authentication technique of FIG. 15.

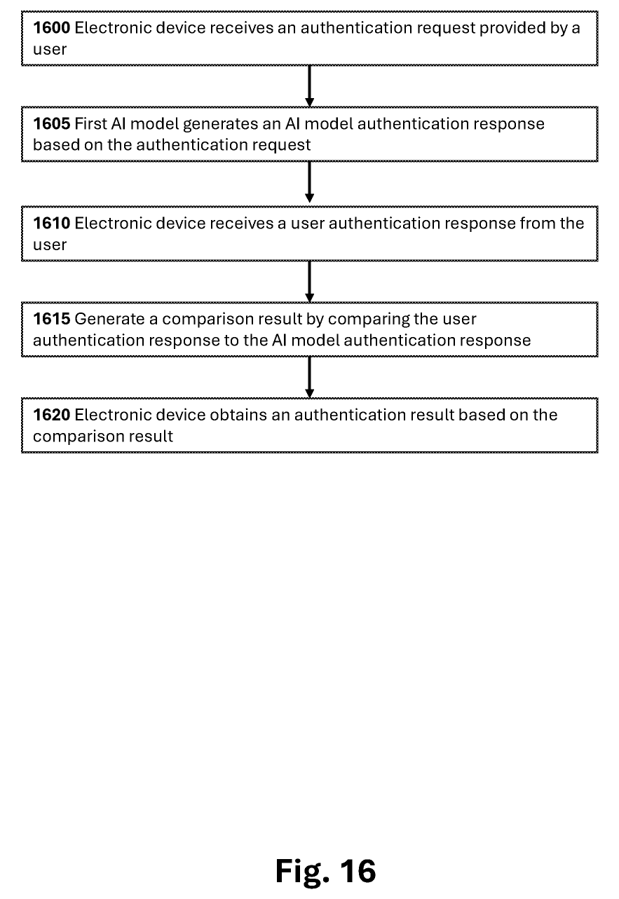

Referring now to FIG. 16, a process is described for authenticating first AI model 1400 by a user. This process can be performed by one or more components of the system shown in FIG. 14.

In step 1600, electronic device 1410 receives an authentication request provided by a user. The authentication request can be of the form described in above connection with FIG. 15.

As part of step 1600, electronic device 1410 may identify the user by obtaining user data relating to the user. Reference is made to the optional part of step 1500 discussed above in this regard. This action can be omitted in the case where electronic device 1410 is confident of the identity of the user, e.g. in the case where electronic device 1410 is a private electronic device such as a phone, tablet or laptop typically used by one user only.

Electronic device 1410 may provide a prompt to the user to assist the user in formulating a robust authentication request. Preferably, the authentication request relates to past actions of the user, a response of the user to a particular stimulus or set of stimuli, and/or to preferences of the user. For example, electronic device 1410 may prompt the user in a manner such as ‘ask the AI to answer a question about your day’, ‘ask the AI to answer a question about your favourite activity’ or ‘watch this video, listen to this audio and/or perform this particular gesture’.

Electronic device 1410 may guide the user through the process of formulating the authentication request. Electronic device may screen questions posed by the user for similarity to recently-asked questions, prompting the user to ask a different question in the case where a question is too similar to a recently-asked question.

In the case of a stimulus-based authentication request, electronic device 1410 may direct the user to experience the stimulus and capture the user’s response. For example, electronic device 1410 may request that the user watch a video, view an image and/or listen to audio generated by electronic device 1410 or another electronic device at the request of electronic device 1410.

In step 1605, first AI model 1400 generates an AI model authentication response based on the authentication request. First AI model 1400 is trained on a training dataset containing historic data relating to the user. Reference is made to the discussion earlier in connection with historic data relating to the user which is equally applicable to the embodiment of FIG. 16. The AI model authentication response can be generated in the same manner as the expected authentication response - see step 1510 above.

In step 1610, electronic device 1410 receives a user authentication response from the user. This step is the same as step 1520 discussed above.

In step 1615, a comparison result is generated by comparing the user authentication response to the AI model authentication response to generate a comparison result. This step is the same as step 1520 discussed above, where the expected authentication response of FIG. 15 is replaced by the AI model authentication response. Preferably, in the case where the comparison is performed by an AI model, this AI model is different from first AI model 1400 so that a situation in which first AI model 1400 is scoring its own authentication response is avoided. The AI model used to perform the comparison may be provided by payment network 1405 or an equivalent system such that the AI model used to perform the comparison is trusted, e.g. first AI model 100.

In step 1620, electronic device 1410 obtains an authentication result based on the comparison result. This step is the same as step 1530 discussed above other than that in the case of FIG. 16 it is first AI model 1400 rather than the user that the authentication result relates to.

Following successful authentication of first AI model 1400, first AI model 1400 may perform one or more actions. For example, in the context of an electronic payment transaction, AI model 1400 may initiate an electronic payment transaction on behalf of the user. Initiating the electronic payment transaction may involve first AI model 1400 receiving an access token from a wallet application, where the access token is associated with a payment instrument of the user. First AI model 1400 may then initiate an electronic payment transaction on behalf of the user using the access token. See the discussion earlier in respect of the actions of second AI model 105.

It will be appreciated that only first AI model 1400 that has been trained on historic user data relating to the user will be able to successfully respond to the authentication request provided in step 1600 by the user. This is because a ‘generic’ AI model that has not been trained on historic user data relating to that specific user will be unable to predict or model the user’s responses with sufficient accuracy to enable the generic AI model to pass the authentication challenge. As such, the process of FIG. 16 enables an AI model to be robustly authenticated by a user.

Authentication of first AI model 1400 may be limited, e.g. after a certain time or a certain number of actions performed by first AI model 1400 on behalf of the user, first AI model 1400 may need to repeat the process of FIG. 16 to re-authenticate itself. Electronic device 1410 may prompt the user when re-authentication is necessary.

Scenarios are possible in which two-way authentication is required, i.e. a user is required to authenticate themselves to first AI model 1400 and first AI model 1400 is required to authenticate itself to the user. In such scenarios the process of FIG. 15 can be performed and then the process of FIG. 16 can be performed. The order in which these processes are performed is not limited, i.e. alternatively the process of FIG. 16 can be performed and then the process of FIG. 15 can be performed.

It will be appreciated that any method step described in any portion of the disclosure above can be implemented in software and/or hardware by one or more appropriately configured computing devices. The disclosure thus encompasses a computer-readable storage medium, which may be non-transitory, that stores instructions that cause one or more computing devices to carry out any one or more of the steps of any of the methods described above. A computer program product comprising said instructions is also contemplated.

It will also be appreciated that the embodiments described herein are purely illustrative and hence are susceptible to many modifications, substitutions, additions and the like. All such modifications, substitutions and additions are within the scope of the invention which is defined by the appended claims. Method steps described in this specification may be implemented in any order, in parallel or sequentially, unless specifically stated otherwise.

1. A computer-implemented method performed as part of an electronic payment transaction, comprising:
receiving, by a verification service from a software agent, a hash of a data package comprising one or more portions of an interaction between the user and the software agent;
generating, by the verification service based on the hash of the data package, a first token; and
transmitting, by the verification service, the first token to the software agent.

2. The computer-implemented of claim 1, further comprising:
receiving, by the verification service from the software agent, user authentication data;
wherein the first token is generated based on the hash of the data package and the user authentication data.

3. The computer-implemented method of claim 1 or 2, further comprising:
receiving, by the verification service, a second token as part of an approval process corresponding to the electronic payment transaction;
comparing, by the verification service, the second token to the first token; and
generating, by the verification service, a verification response based on the comparing.

4. The computer-implemented method of claim 3, wherein the verification response indicates successful verification in the case where the second token is the same as the first token.

5. The computer-implemented method of claim 3, wherein the verification response indicates failed verification in the case where the second token is different to the first token.

6. The computer-implemented method of claim 3, further comprising:
approving or denying the electronic payment transaction based on the verification response.

7. The computer-implemented method of claim 1, further comprising:
receiving, by the verification service, the data package; and
storing, by the verification service, the data package in association with the first token.

8. A non-transitory computer-readable medium storing instructions that, when executed by one or more processors, cause the one or more processors to:
receive, from a software agent, a hash of a data package comprising one or more portions of an interaction between a user and the software agent;
generating, based on the hash of the data package, a first token; and
transmit the first token to the software agent.

9. The non-transitory computer-readable medium of claim 8, wherein the one or more processors are further caused to:
receive, from the software agent, user authentication data;
wherein the first token is generated based on the hash of the data package and the user authentication data.

10. The non-transitory computer-readable medium of claim 8, wherein the one or more processors are further caused to:
receive a second token as part of an approval process corresponding to the electronic payment transaction;
compare the second token to the first token; and
generate a verification response based on the comparing.

11. The non-transitory computer-readable medium of claim 10, wherein the one or more processors are further caused to:
approve or deny the electronic payment transaction based on the verification response.

12. The non-transitory computer-readable medium of claim 8, wherein the one or more processors are further caused to:
receive the data package; and
store the data package in association with the first token.

13. A computing device comprising:
one or more processors; and
memory storing instructions that, when executed by the one or more processors, cause the computing device to:
receive, from a software agent, a hash of a data package comprising one or more portions of an interaction between a user and the software agent;
generate, based on the hash of the data package, a first token; and
transmit the first token to the software agent.

14. The computing device of claim 13, wherein the one or more processors are further caused to:
receive, from the software agent, user authentication data;
wherein the first token is generated based on the hash of the data package and the user authentication data.

15. The computing device of claim 13, wherein the one or more processors are further caused to:
receive a second token as part of an approval process corresponding to the electronic payment transaction;
compare the second token to the first token; and
generate a verification response based on the comparing.

16. The computing device of claim 15, wherein the one or more processors are further caused to:
approve or deny the electronic payment transaction based on the verification response.
